(19) United States
(12) Patent Application Publication
(10) Pub. No.: US 2025/0175968 A1
(43) Pub. Date: May 29, 2025

(54) SYSTEMS AND METHODS FOR RESOURCE INFORMATION INDICATION

(71) Applicant: ZTE CORPORATION, Shenzhen (CN)

(72) Inventors: Shuang ZHENG, Shenzhen (CN); Nan ZHANG, Shenzhen (CN); Ziyang LI, Shenzhen (CN); Wei CAO, Shenzhen (CN); Hanqing XU, Shenzhen (CN)

(73) Assignee: ZTE CORPORATION, Shenzhen (CN)

(21) Appl. No.: 19/041,807

(22) Filed: Jan. 30, 2025

Related U.S. Application Data
(63) Continuation of application No. PCT/CN2023/090178, filed on Apr. 24, 2023.

(51) Int. Cl. H04W 72/044; H04W 72/0446; H04W 72/23

(52) U.S. Cl. CPC H04W 72/046; H04W 72/0446; H04W 72/23

(57) ABSTRACT

Presented are systems and methods for resource information indication. A network node may receive, from a wireless communication node, resource information that is used for at least one of: a first forwarding link, a second forwarding link, a third forwarding link, or a fourth forwarding link. The first forwarding link can be from the wireless communication node to the network node. The second forwarding link can be from the network node to the wireless communication node. The third forwarding link can be from the network node to a wireless communication device. The fourth forwarding link can be from the wireless communication device to the network node.

### CROSS-REFERENCE TO RELATED APPLICATION

This application claims the benefit of priority under 35 U.S.C. § 120 as a continuation of PCT Patent Application No. PCT/CN2023/090178, filed on Apr. 24, 2023, the disclosure of which is incorporated herein by reference in its entirety.

### TECHNICAL FIELD

The disclosure relates generally to wireless communications, including but not limited to systems and methods for resource information indication.

BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A network node may receive, from a wireless communication node, resource information that is used for at least one of: a first forwarding link, a second forwarding link, a third forwarding link, or a fourth forwarding link. The first forwarding link can be from the wireless communication node to the network node. The second forwarding link can be from the network node to the wireless communication node. The third forwarding link can be from the network node to a wireless communication device. The fourth forwarding link can be from the wireless communication device to the network node. The resource information may include at least one of: beam information for access links, or additional information. The additional information may comprise at least one of: frequency information for the access links, panel information for the access links, link-level on/off information, beam information for backhaul links, frequency information for the backhaul links, panel information for the backhaul links, or uplink (UL)/downlink (DL) information. The backhaul links may include the first forwarding link and the second forwarding link. The access links may include the third forwarding link and the fourth forwarding link.

In some embodiments, prior to the network node receiving the resource information, the wireless communication node may have received capability information of the network node. The capability information can be sent to the wireless communication node from an Operations, Administration and Maintenance (OAM) entity. The capability information can be reported from the network node to the wireless communication node. The capability information may include at least one of: a frequency information allocation on access links and/or backhaul links; a simultaneous beam operation capability on the access links and/or the backhaul links; a frequency shift capability; or a sub-band non-overlapping full duplex (SBFD) capability.

In some embodiments, the frequency information may include at least one of following formats: a carrier index, a passband index, a bandwidth part (BWP) index, a subband index, a cell identifier (ID), a starting physical resource block (PRB), a starting resource element (RE), an ending PRB, an ending RE, a number of consecutive PRBs, a number of REs, a RB offset, a RE offset, an absolute radio frequency channel number (ARFCN), or a global synchronization raster channel number (GCSN). The panel information may include at least one of following formats: a panel identity or index, or an antenna group ID or index. The link-level on/off information can be used to indicate an on/off status that is applicable for at least one of: the first forwarding link, the second forwarding link, the third forwarding link, or the fourth forwarding link. The beam information for the backhaul links can be in one of the following formats: a beam index, or a transmission configuration indication (TCI) state.

In some embodiments, when the beam information for the backhaul links is in the format of TCI state, a list that includes one or more TCI states can be configured for the network node to be used for a backhaul link beam information indication. The list can be configured to the network node by the wireless communication node via at least one of: a radio resource control (RRC) signaling, a medium access control control element (MAC CE) signaling, or a downlink control information (DCI) signaling. A set of logic reference signals that is used in a TCI state can be defined for the network node. A set of logic reference signals can be one-to-one mapping to physical backhaul link beams. A new type of TCI state may include a logic beam index which is defined for the network node, and the logic beam index can be one-to-one mapping to physical backhaul link beams. At least one of additional information can be indicated in a same radio resource control (RRC) signaling that is used for a periodic beam information indication of the access links. A format of indication for each type of additional information is one of: the additional information is indicated in a pair with a beam index for the access links configured in a list by a RRC signaling, and each access link beam has the associated corresponding additional information; one field is added to indicate the additional information, and is applicable for all access link beams configured in a list by RRC signaling.

In some embodiments, at least one of additional information can be indicated in a same RRC signaling that used for the semi-persistent beam information indication of access links. A format of indication for each type of additional information can be one of: the additional information is indicated in a pair with a beam index for the access links configured in a list by a radio resource control (RRC) signaling; or one field is added to indicate the additional information, and is applicable for all beam index for the access links configured in the list by the RRC signaling. At least one of additional information can be indicated in a same medium access control control clement (MAC CE) signaling used for a semi-persistent beam indication of the access links. A format of indication for each type of additional information can be one of: one or more fields are added in the MAC CE signaling to indicate one or more additional information, and the one or more additional information is one-to-one mapping to an indicated beam index information of the access links activated in the MAC CE signaling; or one field is added to indicate the additional information, and is applicable for all beam index information of the access links activated in the MAC CE signaling.

In some embodiments, at least one of additional information can be indicated in a same radio resource control (RRC) signaling and a medium access control control element (MAC CE) signaling that are used for a semi-persistent beam indication of the access links. A format of indication for each type of additional information may include: one field is added in the RRC signaling to indicate the additional information, and is applicable for all beam index for the access links configured in a list by the RRC signaling; and one or more fields are added in the MAC CE signaling to update one or more additional information that is used for specific indicated access link beam information. At least one of additional information can be indicated in a same downlink control information (DCI) signaling that is used for an aperiodic beam indication of the access links. A format of indication for each type of additional information can be one of: one or more fields are added in the DCI signaling to indicate the one or more additional information, and is one-to-one mapping to an indicated beam index information of the access links; or one field is added in the DCI signaling to indicate the additional information, and is applicable for all indicated beam index information of the access links.

In some embodiments, at least one of additional information can be indicated in a new signaling. The new signaling may comprise at least one of: a radio resource control (RRC) signaling, a medium access control control element (MAC CE) signaling, or a downlink control information (DCI) signaling. The panel information for the access links can be implicitly indicated by a specific beam index for the access links. The link-level on/off information can be implicitly indicated by a specific beam index for the access links. The link-level on/off information can be implicitly indicated by a time division duplex (TDD) configuration.

In some embodiments, when backhaul link beam information is in a format of transmission configuration indication (TCI) state, a medium access control control element (MAC CE) signaling used to activate or deactivate one TCI state for backhaul link from a radio resource control (RRC) configured TCI state list of control link can be reused to indicate one or more TCI state activated or deactivated from a RRC configured TCI state list for the backhaul link, and the control link includes the first control link from wireless communication node to a network node and the second control link from network node to wireless communication node. A higher layer parameter can be defined for the network node to differentiate whether the indicated TCI state in the MAC CE signaling is from the RRC configured TCI state list of the backhaul link or from RRC configured beam of control link. Backhaul link beam information can be indicated in a new signaling comprises at least one of: a radio resource control (RRC) signaling, a medium access control control element (MAC CE) signaling, or a downlink control information (DCI) signaling. The RRC signaling used for a periodic and/or a semi-persistent access link beam indication can be used to update the backhaul link beam information for one or more indicated access link beam indexes. A field for backhaul link beam indication can be indicated in a pair with a field for a beam index for the access links configured in a list by the RRC signaling. When the field of the backhaul link beam indication is not indicated in the RRC signaling for periodic access link beam indication, the backhaul link beam information associated with a corresponding access link beam can be refer to the backhaul link beam information indicated in the new signaling. The MAC CE signaling used for the semi-persistent access link beam indication can be used to update the backhaul link beam information for one or more indicated access link beam indexes. One or more fields for backhaul link beam indication can be added in the MAC CE signaling to update the corresponding backhaul link beam information for one or more indicated access link beams activated in the MAC CE signaling. When the backhaul link beam indication for a access link beam is not updated in the MAC CE signaling for semi-persistent access link beam indication, the backhaul link beam information associated with a corresponding access link beam can be refer to the backhaul link beam information indicated in the new signaling.

In some embodiments, the network node may receive, from the wireless communication node, a list including one or more beam pairs, each of the beam pair including a first beam index configured for the access links and a second beam information configured for the backhaul links. Each beam pairs in the list may have a corresponding beam pair index. The list can be configured to the network node from the wireless communication node via at least one of: a radio resource control (RRC) signaling, a medium access control control element (MAC CE) signaling, or a downlink control information (DCI) signaling. The list can be configured to the network node via an Operations, Administration and Maintenance (OAM) entity. Access link beam information in different beam pairs of the list can be same or different. Backhaul link beam information in different beam pairs of the list can be same or different. In certain embodiments, access link beam information in different beam pairs of the list can be different, and backhaul link beam information in different beam pairs of the list can be same or different.

In some embodiments, an access link beam information field can be reinterpreted to be used to indicate a beam pair index. A higher layer parameter can be configured to the network node to indicate whether the access link beam information field is used to indicate the beam pair index or access link beam index. The backhaul link beam information can be obtained from the beam pair list according to an indicated access link beam index. When more than one backhaul link beam is obtained for an associated indicated access link beam and the network node supports a simultaneous beam transmission on backhaul link beams, the network node may simultaneously use the backhaul link beams together with the associated access link beam. When more than one backhaul link beam is obtained for an associated indicated access link beam and the network node does not support a simultaneous beam transmission on backhaul link beams, a pre-defined rule can be defined for the network node to determine the backhaul link beam information for the associated access link beam. The pre-defined rule may include at least one of: the backhaul link beam corresponding to the associated access link beam that is first defined in the beam pair list; or the backhaul link beam corresponding to the associated access link beam that is last defined in the beam pair list; or the default backhaul link beam. One or more field can be added in a medium access control control element (MAC CE) signaling of a semi-persistent access link beam information to update the backhaul link beam information for access link beam information activated in the MAC CE signaling.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with some embodiments of the present disclosure;

FIG. 2 illustrates a block diagram of an example base station and a user equipment device, in accordance with some embodiments of the present disclosure;

FIGS. 3A-3E illustrate related aspects of resource information indication, in accordance with some embodiments of the present disclosure;

FIG. 4 is a structure illustrating a conceptual model of a network controlled repeater (NCR), in accordance with some embodiments of the present disclosure;

FIG. 5 illustrates an example of subband non-overlapping full duplex (SBFD), in accordance with some embodiments of the present disclosure; and

FIG. 6 illustrates a flow diagram of an example method for resource information indication, in accordance with some embodiments of the present disclosure.

### DETAILED DESCRIPTION

### 1. Mobile Communication Technology and Environment

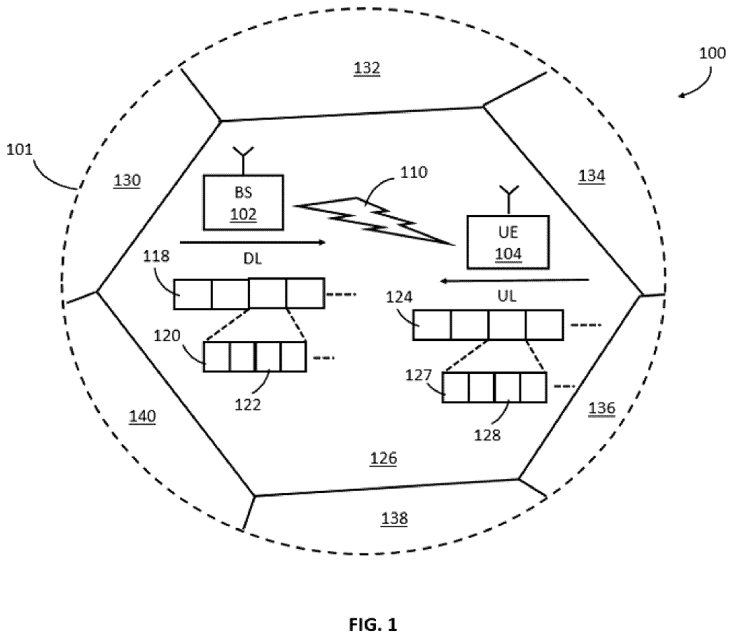

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

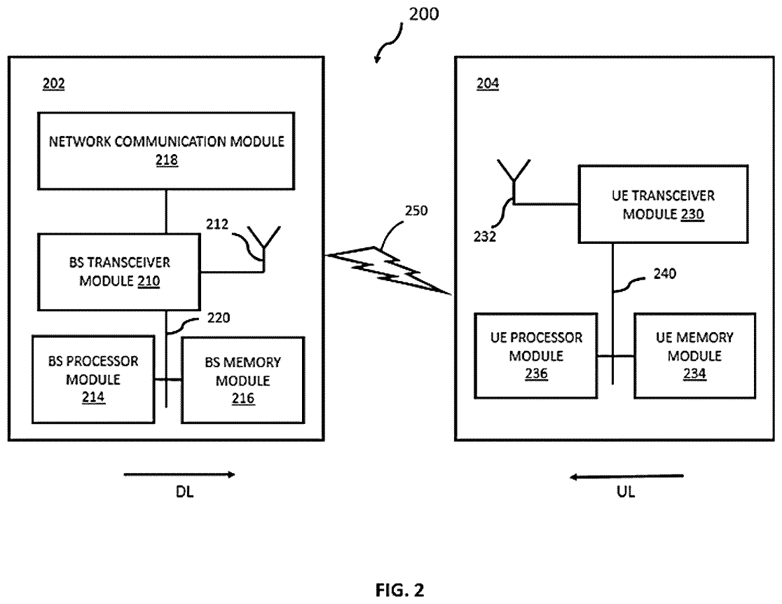

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Resource Information Indication

As the new radio (NR) system moves to higher frequencies (around 4 GHz for FR1 deployments and above 24 GHz for FR2), propagation conditions degrade compared to lower frequencies exacerbating the coverage challenges. As a result, further densification of cells may be necessary. While the deployment of regular full-stack cells is preferred, it may not be always a possible (e.g., not availability of backhaul) or economically viable option. To provide blanket coverage in cellular network deployments with relatively low cost, RF repeaters with full-duplex amplify-and-forward operation may be used in 2G, 3G and 4G systems. However, the major problem brought by the RF repeater is that it amplifies both signal and noise and increases interference in the system.

To cope with this problem, a network controlled repeater (NCR) can be considered. The NCR may be able to receive and process side control information (SCI) from a network. In order to control a forwarding operation of the NCR, some resource information can be utilized to be indicated to the NCR.

Furthermore, a reconfigurable intelligent surface (RIS) can also be considered to enable controllable forwarding. In such case, the resource information indication discussed in the present disclosure can be applicable to RIS as well. The RIS may have a large number of controllable reflection elements, which may be divided into element groups to facilitate efficient control. Each element group SCI can adopt the resource information discussed hereafter as part of the SCI.

In present disclosure, a method for a resource information indication that is used for a forwarding operation of a NCR is proposed for a wireless network. The method included in this disclosure is not limited to a NCR and can also be applicable for smart repeater, enhanced RF repeater, reconfigurable intelligent surface (RIS), and/or integrated access and backhaul (IAB).

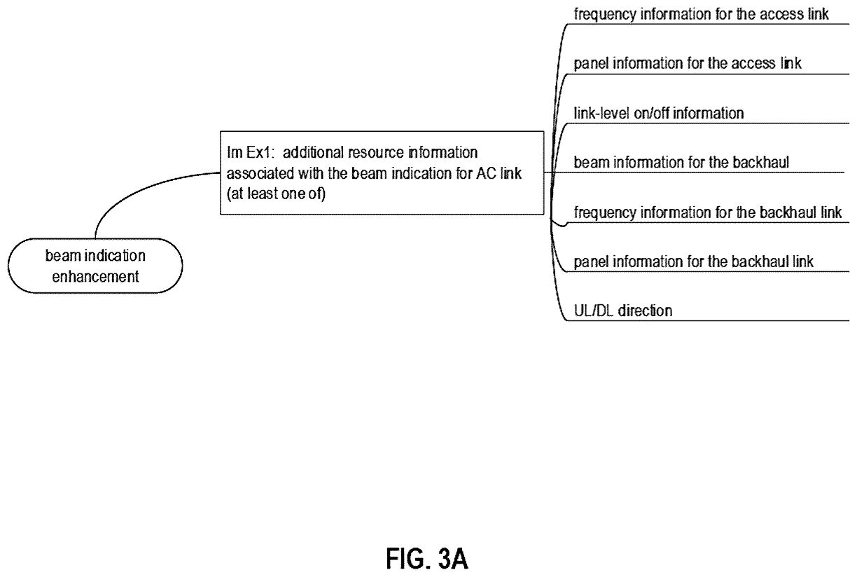

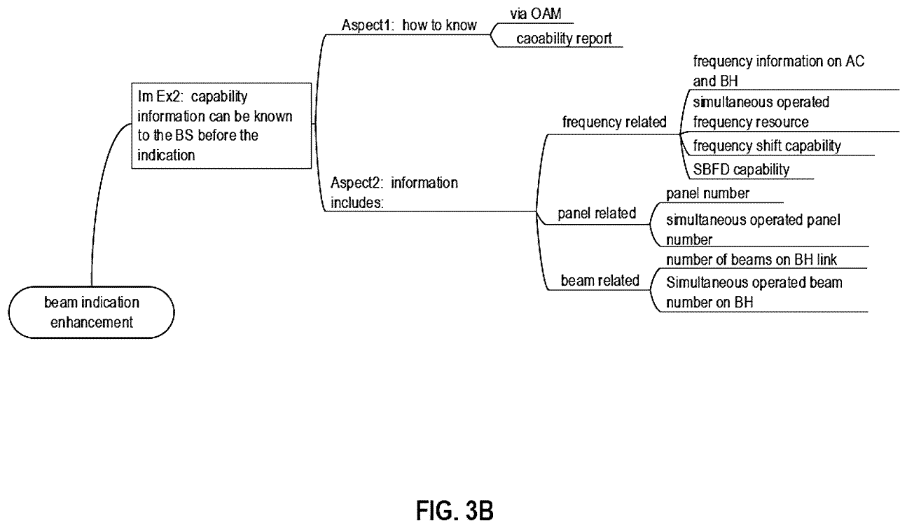

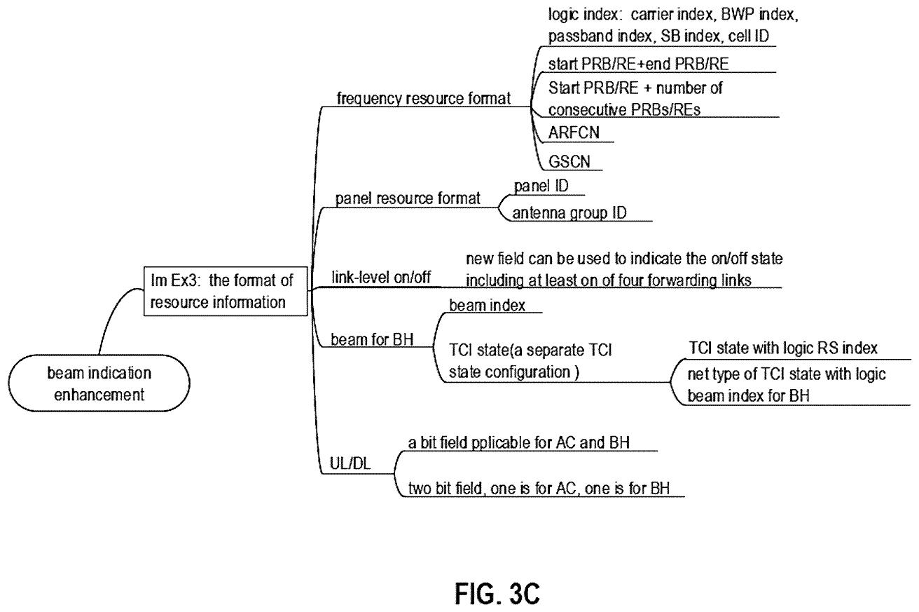

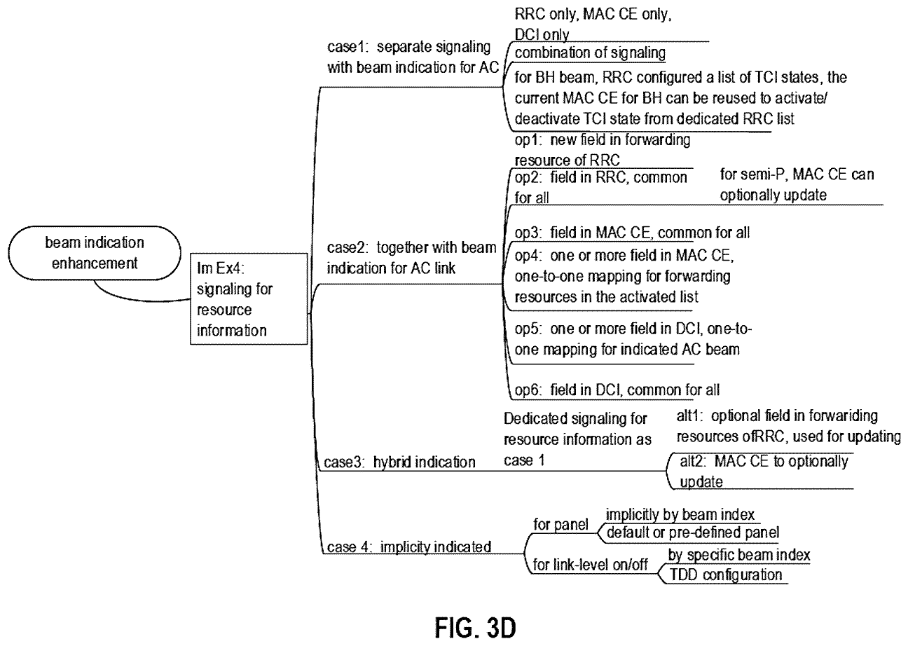

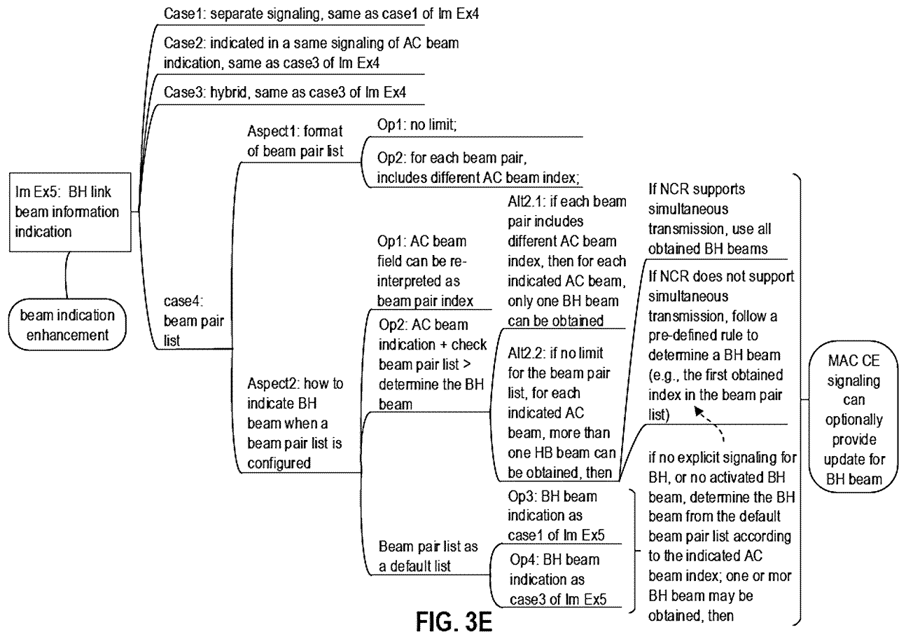

FIGS. 3A-3E illustrate related aspects of resource information indication, in accordance with some embodiments of the present disclosure.

RF repeaters may be used in 2G, 3G and 4G deployments to supplement a coverage provided by regular full-stack cells with various transmission power characteristics. The RF repeaters may constitute a simplest and most cost-effective way to improve network coverage. The main advantages of the RF repeaters can be low-cost, case of deployment, and the fact that the RF repeaters may not increase latency. The main disadvantage can be that the RF repeaters may amplify signal and/or noise, which may contribute to an increase of interference (e.g., pollution) in a system. The RF repeaters may not have a beam management function, which means/indicate that the RF repeaters may not provide beamforming gain in its signal forwarding. Within the RF repeaters, there can be different categories depending on power characteristics and an amount of spectrum configured to amplify (e.g., single band or multi-band). The RF repeaters can be non-regenerative type of relay nodes and may amplify-and-forward everything received. The RF repeaters can be full-duplex nodes and may not differentiate between an uplink (UL) and a downlink (DL) from transmission and/or reception standpoint. With increased traffic demands, there can be a growing interest in novel communication paradigms for future/beyond 5G wireless networks.

An NCR can be located in a selected position with good wireless channel condition (e.g., with LOS path) to the BS. When the NCR starts up, a network integration procedure can be carried out. Via this network integration procedure, the BS may identify the NCR as a network node and may configure the NCR for its following amplify-and-forward operation. After the completion of integration, the NCR may carry out amplify-and-forward operation for UEs in its coverage with the control information received from the BS.

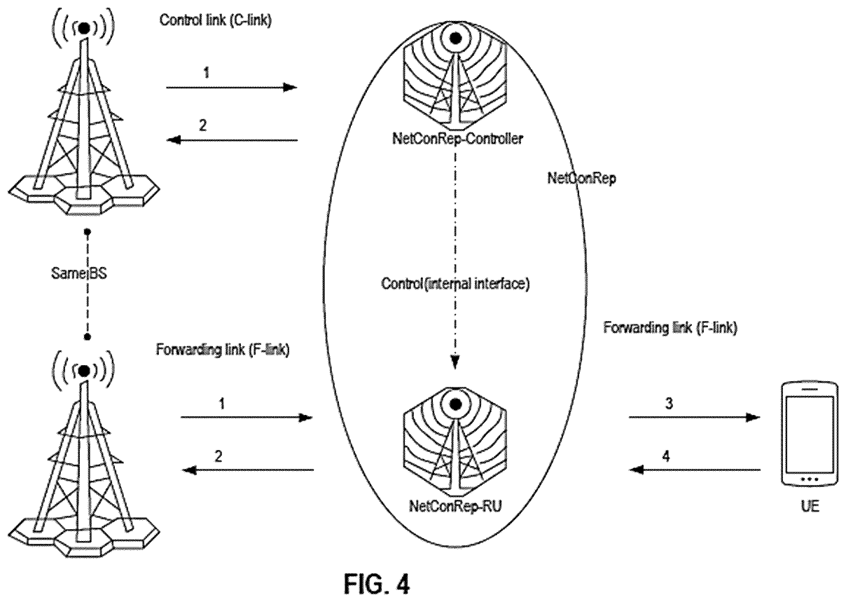

From perspective of functionality, a structure of a NCR is provided in FIG. 4. FIG. 4 is a structure illustrating a conceptual model of a network controlled repeater (NCR), in accordance with some embodiments of the present disclosure. The NCR-Controller may maintain the Control link (C-link) between BS and NCR to enable the information exchanges, e.g., carrying the side control information (SCI). The NCR-RU radio unit (RU) may use the Forwarding link (F-link), which includes the F-link for backhaul (F-link 1&2 or called backhaul link) and F-link for access (F-link 3&4 or called access link), to forward the data between the BS and the UE(s). The behavior of F-link can be controlled according to the received SCI from the BS.

In order to facilitate the forwarding operation of NCR, the control information especially including the beam information can be utilized for the NCR. Following agreements can be achieved for the side control information indication of NCR.

Beam indication for the access link: For each periodic beam indication of access link, RRC signaling can be used to configure a list of forwarding resources, and each forwarding resource can be defined as {Beam index, time resource}. Each time resource can be defined by {Starting slot defined as the slot offset in one period, starting symbol defined by symbol offset within the slot, duration defined by the number of symbols} with dedicated field. The periodicity can be configured as part of the RRC signaling for periodic beam indication, and the same periodicity can be assumed for all time resource(s) in one periodic beam indication. The reference SCS can be configured as part of the RRC signaling for periodic beam indication, and the same reference SCS can be assumed for all time resource(s) in one periodic beam indication. For each aperiodic beam indication for access link, a list of time resource can be pre-defined by RRC signaling. Each time resource can be defined by {Starting slot defined as the slot offset, starting symbol defined by symbol offset within the slot, duration defined by the number of symbols} with dedicated field. A new DCI signaling can be used with one or multiple fields to indicate the beam information and each field refers to one beam index, and also one or multiple fields to indicate the time resource defined by RRC. The time indication and beam indication in the DCI signaling can be sequentially associated with one to one mapping. For semi-persistent beam indication for access link, RRC may configure one or multiple list of forwarding resource, each list can include one or multiple forwarding resources, and each forwarding resource can be defined by {beam index, time resource}. Each time resource can be defined by {Starting slot defined as the slot offset in one period, starting symbol defined by symbol offset within the slot, duration defined by the number of symbols} with dedicated field. The periodicity and reference SCS can be configured as part of the RRC signaling for each list of forwarding resource. A new MAC-CE can be used to activate/de-activate one of all configured list in RRC, thus all the forwarding resources in this list can be selected. The MAC-CE signaling can also optionally provide update for beam index in the forwarding resource.

Beam indication for the backhaul link: As for the backhaul link, the semi-static beam indication can be considered for backhaul link. If a beam indication framework is used for NCR-MT, the DL beam can be indicated by a new MAC CE to select one of TCI state ID from the RRC-configured list of beams for C-link, while the UL beam can be indicated by SRI on C-link via a new MAC CE signaling. If another beam indication framework is used for NCR-MT, the DL and UL beam can be indicated by a new MAC CE to select one of TCI state ID from the RRC-configured list of beams for C-link.

On/off indication of the NCR-Fwd: The “ON” state of NCR-Fwd can be implicitly indicated via the access link beam indication (e.g., if there is an AC link beam indication, the NCR can be assumed to be ON over the indicated time domain resource associated with corresponding beam(s)). The backhaul link can be following the access link in terms of on/off.

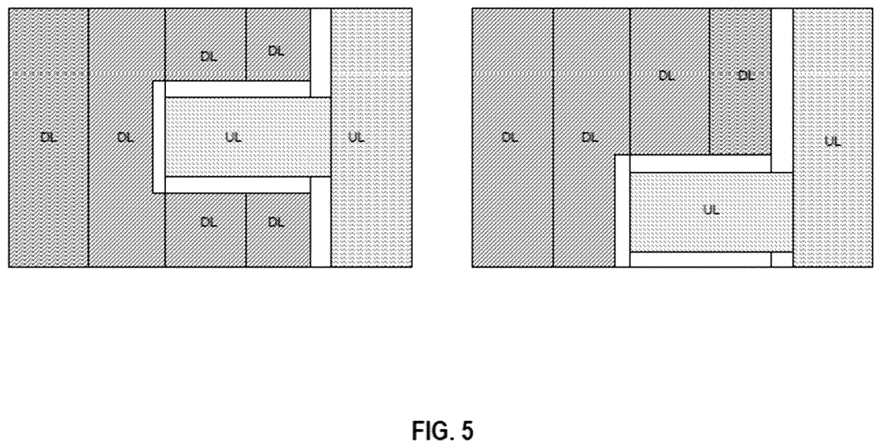

Subband non-overlapping full duplex (SBFD): The SBFD can be a new duplex mode with the TDD carrier split into sub-bands to enable simultaneous transmission and reception in the same slots. FIG. 5 illustrates an example of subband non-overlapping full duplex (SBFD), in accordance with some embodiments of the present disclosure. In FIG. 5, the UL subband (SB) can be supported to be configured in the DL and/or flexible symbols/slots.

### Implementation Example 1: What Resource Information can be Utilized to be Indicated for a Forwarding Operation of NCR

In present disclosure, in order to enable and control a forwarding operation of a NCR, beam information for an access link can be indicated to the NCR by a BS. The beam indication method for the access link of NCR may include a periodic beam indication, a semi-persistent beam indication, and/or an aperiodic beam indication. In addition to the beam information for the access link, at least one of following information is also utilized to be indicated by the BS to the NCR:

(1) The frequency information for the access link can be used to indicate the frequency resource for the access link. For example, when the NCR-Fwd has multiple carriers/bands for the access link, the frequency information can be indicated to the NCR to indicate which carrier/bands can be used when the NCR forwards a signal on the access link.

(2) The panel information for the access link can be used to indicate the panel information for the access link. For example, when the NCR-Fwd has multiple panels/TRPs for the access link, the panel information can also be indicated.

(3) The link-level on/off information can be used to indicate an on/off state of one or more links. In the present disclosure, the ‘ON’ state of NCR-Fwd is implicitly indicated via the access link beam indication, and the backhaul link is following the access link in terms of on/off state, so if the access link has beam indication and is ‘on’ for the corresponding time resource, the backhaul link can also keep ‘on’ state. However, sometimes the link-level on/off can be utilized for some cases. For example, in order to measure the self-interference, the access link may keep ‘on’ while the backhaul link needs to keep ‘off’ for a time duration. For another example, in order to realize the UL-only forwarding, the forwarding link 2+4 may be ‘on’, while the forwarding link 1+3 can be keep ‘off’. Thus, in order to realize the link-level on/off for the NCR-Fwd, the link-level on/off indication can be utilized.

(4) The beam information for the backhaul link may represent the beam information that can be used for the forwarding operation of the NCR for the backhaul link. In present disclosure, since the C-link and backhaul link operate in a same band, the beam information indication for backhaul link may share the same spatial filter of C-link, so the beam information for the backhaul link can share the same RRC configuration of beams for the C-link, or reuse the SRI of C-link. However, in some cases, the spatial filter of C-link cannot be shared with the backhaul link, which means that the RRC configuration of beams for the C-link cannot be shared with the backhaul link. For example, when the C-link and backahul link operates in the different bands (e.g., the C-link operates in FRI while the backhaul link operates in FR2), or when the C-link and backhaul link operates in different panels, or when the NCR-MT and NCR-Fwd are in different locations, the RRC-configured list of TCI states for C-link cannot be shared with the backhaul link. In such way, new beam indication methods for the backhaul link can be considered.

(5) The frequency information for the backhaul link can be used to indicate the frequency resource that is used for the backhaul link. For example, when the NCR-Fwd has multiple carriers/bands for the backhaul link, the frequency information that is used for the forwarding operation of backhaul link can be indicated to the NCR.

(6) The panel information for the backhaul link can be used to indicate the panel information that is used for the backhaul link. For example, when the NCR-Fwd has multiple panels/TRPs for the backhaul link, the panel information that is used for the forwarding operation of backhaul link can also be indicated to the NCR.

(7) The UL/DL information for the access link and/or backhaul link can be used to indicate the direction information for the access link beam indication and/or backhaul link beam. For example, when the NCR-Fwd supports the subband non-overlapping full duplex, it may indicate/mean that the NCR-Fwd may simultaneously operate the DL forwarding and UL forwarding on access link during the SBFD symbol/slots. In such way, the NCR-Fwd may know the indicated beam on the SBFD symbol/slots is used for the DL forwarding or UL forwarding, thus the UL/DL information can be utilized.

### Implementation Example 2: How to Make BS Know Capability Information of NCR

As introduced in implementation example 1, the frequency information, panel information for the access link and/or the backhaul link, and the backhaul link beam information may also be indicated associated with the access link beam information from the BS to the NCR. Before the indication, the BS may know the capability information about the NCR-Fwd's frequency information and/or panel information and/or backhaul link beam information. In such case, following aspects can be considered.

Aspect 1: how the BS know the capability information:
Option 1: The capability information can be configured to the BS via the OAM.
Option 2: The capability information can be reported to the BS from the NCR.

Aspect 2: what the capability information may include:
The capability information related to the frequency information may include at least one of following: (1) the number of frequency resource supported on the NCR-Fwd for the access link and/or the backhaul link; (2) the number of frequency resource for simultaneous transmission supported on the NCR-Fwd for the access link and/or the backhaul link; (3) the frequency shift capability; (4) the frequency information allocation for the access link and/or backhaul link; or (5) the SBFD capability. For the number of frequency resource for simultaneous transmission supported on the NCR-Fwd, the frequency resource can be a carrier, a BWP, or a passband. For the frequency shift capability, the frequency shift capability can be used to indicate whether the NCR-Fwd supports the frequency shift on the access link and/or the backhaul link. For the SBFD capability, the SBFD capability can be used to indicate whether the NCR-Fwd can support the SBFD on the access link and/or the backhaul link. For the frequency information allocation for the access link and/or backhaul link, the frequency information allocation for the access link and/or backhaul link can be the sub-band or passband allocation on the access link and/or backhaul link.
The capability information related to the panel information may include at least one of following: (1) the number of panels supported on the NCR-Fwd; or (2) the number of panels for simultaneous transmission supported on the NCR-Fwd. For the number of panels supported on the NCR-Fwd, the number of panels can be the panel information supported on the NCR-Fwd for the access link and/or backhaul link, respectively. For the number of panels for simultaneous transmission supported on the NCR-Fwd, the number of panels for simultaneous transmission supported on the NCR-Fwd can be the simultaneous operated panel information supported on the NCR-Fwd for the access link and/or backhaul link, respectively.
The capability information related to the beam information for the access link and/or backhaul link may include at least one of following: (1) the number of beams supported for the backhaul link and/or access link; (2) the number of beams that can simultaneous transmission for the backhaul link and/or access link; (3) the beam arrangement/association for the backhaul link and/or access link; (4) the beam used for the backhaul link and/or access link; (5) the number of beams used for the backhaul link and/or access link; or (6) the beam index for the backhaul link and/or access link.

### Implementation Example 3: Format and Interpretation of Resource Information

As discussed above, the resource information can have the explicit indication or the implicit indication. If explicit indication is considered, the format of the resource information can have following options respectively.

(1) The format and interpretation of the frequency information may include at least one of following options, the below options can be applicable for both the frequency information of access link and frequency information of the backhaul link.
Option 1: Use logic index to indicate the frequency information.
   Example 1: In some embodiments, when multiple carriers or multiple bands are considered for the NCR-Fwd, the logic index can be interpreted as one of a carrier index, a passband index, or a bandwidth part (BWP) index. For example, in an NR system, NBWP dedicated BWPs can be configured per NCR. For example, if NBWP=4, 2 bits can be utilized for the BWP index. Similarly, the bit size can be determined if multiple carriers are configured.
   Example 2: In some embodiments, when the NCR-Fwd supports the SBFD, the logic index can be interpreted as the subband index.
   Example 3: In some embodiments, the logic index can be interpreted as cell ID or cell index. For example, when multiple carriers or multiple bands are considered for the NCR-Fwd, a single carrier can be used as a Scell. In such way, in order to indicate the different carrier for the beam information, the cell ID can be used to indicate the frequency information.
Option 2: Start PRB and/or start RE+end PRB and/or end RE.
Option 3: Start PRB and/or start RE+number of consecutive PRBs and/or number of consecutive REs.
Option 4: An absolute radio frequency channel number (ARFCN).
Option 5: A global synchronization raster channel number (GCSN).
Option 6: One or more offset value from a reference or a specific frequency information. For example, if the BS wants to indicate the frequency information of access link, the reference frequency information can be a pre-defined frequency information, or the frequency information of backhaul link. If the frequency information for the access link is indicated to the NCR, the reference information for the DL frequency information and UL frequency information of access link can be same or different. If the frequency information for the backhaul link is indicated to the NCR, the reference information for the DL frequency information and UL frequency information of backhaul link can be same or different. The offset value can be positive value or negative value. In some embodiments, if the frequency information of access link is indicated to the NCR, there can be same or different indicated offset value for the frequency information of DL and UL for the access link. If the frequency information of backhaul link is indicated to the NCR, there can be same or different indicated offset value for the frequency information of DL and UL for the backhaul link. In some examples, the format of offset value can be the number of PRB and/or the number of REs.
Example 1: The frequency information can be fixed for backhaul link. In this way, the BS can indicate the frequency information of access link to the NCR. The frequency information of backhaul link can be treated as a reference information, thus one or more offset value is indicated to the NCR from the OAM or the BS for the frequency information indication of access link. In some embodiments, if the frequency information for the DL and UL of access link is different, two offset value can be indicated to the NCR. The offset value can be positive or negative. For example, if the frequency information of backhaul link is f0, two positive offset value delta1 and delta2 can be indicated to the NCR for the DL and UL, respectively. The frequency information used for the DL transmission of access link can be f0+delat1, and the frequency information used for the UL reception of access link can be f0+delta2. In other examples, a positive value delat1 and a negative value delat2 can be indicated to the NCR for the DL and UL, respectively. In this way, the frequency information used for the DL transmission of access link can be f0+delat1, and the frequency information used for the UL reception of access link can be f0-delta2. In other embodiments, if the frequency information for the DL and UL of access link is same, one offset value can be indicated to the NCR.
   Example 2: The frequency information of access link can be fixed. Thus the frequency information can be indicated to the NCR by treating the access link beam information as a reference point. For example, the frequency information of access link can be f1 and same for the DL and UL. If the frequency information for the DL and UL of backhaul link is same, one offset value can be indicated to the NCR.
   Example 3: The frequency information of backhaul link can be fixed. The frequency information for the DL can be f0. The frequency information for the UL can be f1. In this way, when indicating the access link frequency information, if the frequency information of DL and UL for the access link is different, the reference information for the frequency information of DL transmission and UL reception of access link can be different. For example, the reference information for the frequency information of DL transmission of access link can be the DL frequency information of backhaul link, while the reference information for the frequency information of UL reception of access link is the UL frequency information of backhaul link. In this way, two positive offset value delta1 and delat2 can be indicatied for the DL and UL of access link, respectively. Thus, the frequency information used for the DL transmission of access link can be f0+delat1, and the frequency information used for the UL transmission of access link can be f1+delta2.
   Example 4: The frequency information of backahul link can be fixed as f0. The frequency information of backhaul link can be treated as a reference information, thus one or more offset value can be indicated to the NCR from the OAM or the BS for the frequency information indication of access link. In some embodiments, if the frequency information for the DL and UL of access link is different, two offset value delat1 and delta2 can be indicated to the NCR for the DL and UL of access link, respectively. In some examples, the indicated offset value can be an integer value that does not represent the positive or negative. The frequency information of access link can be obtained by a default rule or a pre-defined rule, which can add the offset value to the reference frequency information, or can subtract the indicated offset value from the reference frequency information. Thus, if the default rule is that the access link frequency information is obtained by adding the indicated offset value to the reference frequency information, the frequency information for the DL and UL of access link is f0+delta1, f0+delta2, respectively. In some examples, a higher layer parameter can be configured to the NCR from the BS to indicate whether the frequency information of access link is obtained by adding the offset value to the reference frequency information or subtracting the offset value from the reference frequency information.

In some embodiments, the start PRB, the end PRB, the number of consecutive PRBs, the start RE, the end RE, the number of REs can be presented by a PRB number and a RE number, respectively. In addition, the start PRB and the end PRB can also be presented by an offset from a reference point (e.g., point A).

(2) The format and interpretation of the panel information may include at least one of following options, the below options can be applicable for both the panel information of access link and panel information of the backhaul link.
Option 1: Panel ID/index.
Option 2: Antenna group ID/index.

(3) The format and interpretation of the link-level on/off information may include at least one of following options.
Option 1: The new field can be used to indicate the on/off state including at least one of following links: the forwarding link 1; the forwarding link 2; the forwarding link 3; or the forwarding link 4.

Following examples are given to have a further illustration about the interpretation of this field.
Example 1: The new field may have one bit. In some embodiments, the bit value 0 may represent the off state of access link (e.g., the forwarding link 3 and 4), the bit value 1 may represent the off state of backhaul link (e.g., the forwarding link 1 and 2). In other embodiments, the bit value 1 may represent the off state of access link (e.g., the forwarding link 3 and 4), the bit value 0 may represent the off state of backhaul link (e.g., the forwarding link 1 and 2).
Example 2: The new field may have two bits, and different values may represent the different on/off state for different links. In some embodiments, the bit value 0 represents only the forwarding link 1 is ‘on’, the bit value 1 represents the only the forwarding link 2 is ‘on’, the bit value 2 represents only the forwarding link 3 is ‘on’, the bit value 4 represents only the forwarding link 4 is ‘on’.
Example 3: The new field may have two bits, and different values may represent the different on/off state for different combination of links. In some embodiments, the bit value 0 represents only the forwarding link 1 and 2 are ‘on’, the bit value 1 represents only the forwarding link 3 and 4 are ‘on’, the bit value 2 represents only the forwarding link 1 and 3 are ‘on’, the bit value 3 represents only the forwarding link 2 and 4 are ‘on’. In other embodiments, the bit value 0 represents the forwarding link 1 and 2 are ‘off’, the bit value 1 represents the forwarding link 3 and 4 are ‘off’, the bit value 2 represents the forwarding link 1 and 3 are ‘off’, the bit value 3 represents the forwarding link 2 and 4 are ‘off’.

(4) The format and interpretation of the beam information for the backhaul link may include at least one of following options.
Option 1: Beam index. The backhaul link can also use the beam index to represent the beam information.
Option 2: TCI state. The backhaul link can use the TCI state to represent the beam information. Since the RRC configuration of TCI state for the C-link cannot be shared for the backhaul link, a dedicated TCI state list for backhaul link can be configured for NCR- Fwd from the BS via at least one of a RRC, a MAC CE, or a DCI signaling, or configured via OAM. However, since no dedicated reference signal is used for backhaul link, following options can be considered for the format of TCI state configured for the backhaul link.
   Alt 2.1: The current format of TCI state can be reused, and a set of logic reference signal (e.g., CSI-RS) index/ID can be defined for the NCR-Fwd by BS or by OAM. The defined logic reference signal index/ID can be mapped to the corresponding forwarding beam of NCR-Fwd for the backhaul link, and the mapping relationship may be indicated to NCR-Fwd by BS via at least one of a RRC, a MAC CE, a DCI signaling, or indicated to NCT-Fwd and/or BS via OAM. In such way, the logic reference signal ID can be used in the TCI state configured for the backhaul link.
   Alt 2.2: A new type of TCI state can be defined to indicate the beam information for backhaul link. The format of the new type of TCI state can directly include a logic index/ID instead of reference signal with QCL type D. The logic index/ID can be mapped to the forwarding beam of NCR-Fwd on backhaul link. This new type of TCI state can be only applicable for NCR, which is absent for the UE.

(5) The format and interpretation of the UL/DL direction information may include at least one of following options.
Option 1: A bit field to indicate the UL/DL direction applicable for both access link and backhaul link.
Option 2: Two separate bit field, with one bit field can be used to indicate the UL/DL direction for access link, the other one bit field can be used to indicate the UL/DL direction for the backhaul link.

### Implementation Example 4: How to Indicate Above Resource Information Associated with Beam Indication for Access Link

There can be multiple resource information introduced in the implementation example 1, and the format of the resource information may have different options mentioned in implementation example 3. The signaling of the resource information can be considered with following cases. The resource information mentioned in the below cases and options can refer to any of the resource information described in the implementation example 1. Different resource information can have the same or different signaling options mentioned below.

Case 1: The resource information can be indicated separately with the beam indication of access link. In such way, the resource information can be indicated via at least one of: a radio resource control (RRC) signaling, a medium access control control element (MAC CE) signaling, or a downlink control information (DCI) signaling, which is separate signaling with the beam indication for the access link. Combination of different layer signaling can be also possible to save signaling cost. Different resource information can be indicated in a same signaling or different signaling.
Option 1: RRC only, MAC CE only, and/or DCI only. Semi-static or common resource information can be configured or indicated via a RRC signaling and/or a MAC CE signaling, which may not change frequently. The major benefit is to save dynamic signaling cost. For example, if a common access link frequency information is applied for all beams indication for access link, it can be configured via a RRC signaling and/or a MAC CE signaling.
Option 2: RRC+MAC CE+DCI, RRC+DCI, MAC CE+DCI, and/or RRC+MAC CE. A set of candidate resource information can be configured via a RRC signaling. Then a MAC CE and/or a DCI can be used to activate/deactivate a subset or one of the resource information from a candidate resource set. For example, a list of TCI states dedicated for the beam indication of backhaul link can be configured via a RRC signaling. The format of TCI states for the backhaul link can refer to the implementation example 3. One or more of TCI states can activated/deactivated from the list via a MAC CE signaling. For another example, a list of TCI states for the beam indication of backhaul link can be configured via a RRC signaling. One or more of TCI state can selected from the list via a DCI signaling.

As for the backhaul link beam information, since in the backhaul link beam indication of a NCR, the MAC CE signaling can be used to activate/deactivate a TCI state from the RRC configured beam list of C-link. In such case, if a list of TCI states dedicated for the beam indication of backhaul link can be configured via a RRC signaling, and the format of TCI states for the backhaul link can refer to the implementation example 3, the MAC CE signaling can be reused with some interpretations. The TCI state activated or deactivated in this MAC CE signaling can be from the dedicated TCI state list configured for the NCR-Fwd. In some embodiments, in order to differentiate whether the TCI state activated/deactivated in the MAC CE signaling is from the RRC configured beams of C-link or backhaul link, a higher layer parameter can be defined. For example, a bit field, where the bit value 1 may represent the TCI state activated/deactivated in the MAC CE signaling is from the RRC configured beams of backhaul link, and bit value 0 may represent TCI state activated/deactivated in the MAC CE signaling is from the RRC configured beams of C-link, and vice-versa, can be defined. In other examples, if this higher layer parameter is configured, it may indicate/mean that the TCI state activated/deactivated in the MAC CE signaling is from the RRC configured beams of backhaul link. If not configured, it may indicate/mean that the TCI state activated/deactivated in the MAC CE signaling is from the RRC configured beams of C-link.

Case 2: The resource information can be explicitly indicated in a same signaling together with the beam indication of the access link. There can be three different beam indication mechanisms for the access link (e.g., a period, an aperiod, and a semi-persistent beam indication method), and these three beam indication mechanisms may include a RRC signaling, a MAC CE signaling, and/or a DCI signaling. How to signal the resource information together with the beam indication of access link can be considered from following options.
Option 1: For the periodic and semi-persistent access link beam indication, the RRC signaling can be used to configure a list of forwarding resources, and each forwarding resource can be defined as {beam index, time resource}. In such way, a new field can be added in the forwarding resource of the RRC signaling to indicate the resource information, which may mean that each forwarding resource is defined as {beam index for access link, resource information, time resource}. In some embodiments, the new field can be optional. If this field is not configured, a default resource information or a pre-defined resource information can be used for the indicated access link beam if this field is not configured in the forwarding resource. The default resource information or a pre-defined resource information can be configured to the NCR via an Operations, Administration and Maintenance (OAM) entity.
   Example 1: The backhaul link beam information can be indicated in the forwarding resource. In such way, the forwarding resource in the RRC signaling can be defined as {beam index of access link, beam information of backhaul link, time resource}.
Option 2: For the current periodic and semi-persistent access link beam indication, the RRC signaling can be used to configure a list of forwarding resources, and each forwarding resource can be defined as {Beam index, time resource}. In such case, for the RRC signaling of periodic beam indication and RRC signaling of semi-persistent beam indication, the new field for the resource information indication can be configured as part of the RRC signaling, and the same resource information can be assumed for all indicated access link beam in one list of forwarding resources.
   Example 1: For the periodic beam indication for access link, a field can be added in the corresponding RRC signaling to indicate the resource information (e.g., the frequency information for access link) applicable for all indicated access link beams in the list, which is similar as the periodicity and SCS configuration in the periodic beam indication.
   Example 2: For the semi-persistent beam indication for access link, a field can be added in the corresponding RRC signaling to indicate the resource information (e.g., the panel information for access link) applicable for all indicated access link beams in the list, which is similar as the periodicity and SCS configuration in the semi-persistent beam indication. Besides, in the present disclosure, for the semi-persistent access link beam indication, RRC signaling can be used configures one or multiple list of forwarding resource. Each list can be include one or multiple forwarding resources. A MAC CE signaling can be used to activate/de-activate one of all configured list in a RRC signaling. All the forwarding resources in this list can be selected. The MAC-CE signaling can also optionally provide update for beam index in the forwarding resource. In such way, in some embodiments, if the new field is added in the RRC signaling and is common for all forwarding resources in the list, the MAC CE can also optionally provide update for the resource information in the forwarding resource to enable flexibility.
   Example 3: For the backhaul link beam information configured in the RRC signaling that applicable for all forwarding resources in the list, if the NCR wants to update the backhaul link beam that can be used for some forwarding resources of the activated list by the MAC CE signaling, the MAC CE signaling can be used to optionally provide updates for the backhaul link beam for some forwarding resources.
Option 3: In present disclosure, for the semi-persistent access link beam indication, a RRC signaling can be used configures one or multiple list of forwarding resource. Each list can be consisted of one or multiple forwarding resources. A MAC CE signaling can be used to activate/de-activate one of all configured list in RRC. All the forwarding resources in this list can be selected. This MAC-CE signaling can also optionally provide update for beam index in the forwarding resource. In such case, a new field can be added in the MAC CE signaling to indicate the resource information, and this indicated resource information can be common for all forwarding resources in the activated list.
Option 4: In present disclosure, for the semi-persistent access link beam indication, a RRC signaling can be used configures one or multiple list of forwarding resource. Each list may include one or multiple forwarding resources. A MAC CE signaling can be used to activate/de-activate one of all configured list in the RRC signaling. All the forwarding resources in this list can be selected. The MAC-CE signaling can also optionally provide update for beam index in the forwarding resource. In such case, one or multiple fields can be added in the MAC CE signaling to indicate the resource information, and the indicated resource information can be one-to-one mapping to the forwarding resources in the activated list sequentially. The number of fields added in the MAC CE can be same as the number of forwarding resources in the activated list.
Option 5: In present disclosure, for the aperiodic access link beam indication, a list of time resource can be pre-defined by a RRC signaling. A new DCI signaling can be used with one or multiple fields to indicate the beam information. Each field may refer to one beam index, and also one or multiple fields to indicate the time resource defined by the RRC signaling. And the one or more beam information fields and one or more time resource fields are sequentially associated with one-to-one mapping. In such way, one or multiple fields can be added in the DCI signaling to indicate the resource information, and this indicated resource information can be associated with the access link beam information and the time resource information in the DCI signaling sequentially with one-to-one mapping.
Option 6: In present disclosure, for the aperiodic access link beam indication, a list of time resource can be pre-defined by a RRC signaling. A new DCI signaling can be used with one or multiple fields to indicate the beam information. Each field may refer to one beam index, and also one or multiple fields to indicate the time resource defined by the RRC signaling. And the one or more beam information fields and one or more time resource fields are sequentially associated with one-to-one mapping. In such way, a new field can be added in the DCI signaling to indicate the resource information, and this indicated resource information can be applicable for all indicated access link beam and time resource in the DCI signaling.
Option 7: In present disclosure, for the aperiodic access link beam indication, a list of time resource can be pre-defined by a RRC signaling. A new DCI signaling can be used with one or multiple fields to indicate the beam information. Each field may refer to one beam index, and also one or multiple fields to indicate the time resource defined by the RRC signaling. And the one or more beam information fields and one or more time resource fields are sequentially associated with one-to-one mapping. In such way, a new field can be added in the corresponding RRC signaling to indicate the resource information, and this indicated resource information can be applicable for all indicated access link beam and time resource information in the DCI signaling.

Case 3: The resource information can be configured in a separate signaling with the access link. A beam indication and the resource information can be updated within the access link beam indication signaling. As described in the case 1 of implementation example 4, the resource information can be indicated to the NCR via the signaling that is different from the access link beam indication, and all options that listed in the case 1 of implementation example 4 can be considered. In such case, in order to enable the flexibility and dynamic, following alternatives can be considered.
Alt 1: For periodic access link beam indication and/or semi-persistent access link beam indication, a new field can be added in the forwarding resource of a RRC signaling, which may mean that each forwarding resource is defined as {beam index for access link, resource information, time resource}. This field can be optional. If the NCR wants to update the corresponding resource information for some forwarding resources, this field can be configured in the forwarding resource. If not configured, the resource information associated with the indicated access link beam can refer to the resource information in a separate signaling as described in case 1 of implementation example 4.
   Example 1: The backhaul link beam information can be indicated in a new signaling as described in the any of options of the case 1 in implementation example 4. This backhaul link beam information can be treated as an initial backhaul link beam. If the backhaul link beam information field in the some forwarding resources is configured, then for these forwarding resources, the configured backhaul link beam can be used. For those forwarding resources that not configured the backhaul link beam information field, the initial backhaul link beam indicated in a dedicated signaling can be used.
Alt 2: For semi-persistent access link beam indication, the MAC CE signaling can optionally update the resource information for some forwarding resources in the activated list.
   Example 1: The frequency information for the access link can be indicated in a new signaling as described in the any of options of the case 1 in implementation example 4. For the semi-persistent access link beam indication, the MAC CE signaling may have activated a list, and if the frequency information for some forwarding resources requires a change, the MAC CE signaling can be used to optionally update the access link frequency information for some forwarding resources in the activated list.

As mentioned in the above options of case 1, case 2 and case 3, the MAC CE signaling can be used to update the resource information for some forwarding resources in the activated RRC list. In the way, following options can be considered for the format of MAC CE signaling to update the resource information:
Option 1: One or more fields can be added in the MAC CE signaling to indicate the forwarding resource index, and one or more fields can be added in the MAC CE signaling to indicate the updated resource information. The one or more fields for forwarding resource index and one or more fields for updated resource information can be sequentially associated with one-to-N(with N≥1) mapping or N-to-one (with N≥1) mapping. In some embodiments, a new field can be added in the MAC CE signaling to indicate whether there are updated resource information in this MAC CE signaling.
Option 2: A bitmap can be indicated in the MAC CE signaling to indicate which one or more forwarding resources are needed to update the resource information, where each bit in the bitmap can be corresponding to a forwarding resource and the bit value represents whether or not the corresponding forwarding resource needs to be updated the resource information. If one or more forwarding resources require an update to resource information, one or more fields can be added in the MAC CE signaling to indicate the updated resource information for corresponding forwarding resources, respectively. For example, the bit value 1 may represent the corresponding forwarding resource needs to update the resource information while the bit value 0 may represent the corresponding forwarding resources does no need to update the resource information, or vice versa. For example, if the activated RRC list includes 3 forwarding resources, a bitmap 110 including 3 bits can be used in the MAC CE signaling, the lowest bit in the bitmap is corresponding to the first forwarding resources in the activated RRC list, and second bit represents the second forwarding resources in the activated RRC list, the most significant bit in the bitmap represents the last forwarding resources in the activated RRC list. In this way, if bit value 1 represents the corresponding forwarding resources needs to update the resource information, it may mean the second and last forwarding resources needs to update the resource information, then two fields is indicated in the MAC CE signaling to indicate the updated resource information for the second and last forwarding resources, respectively. For another example, if the most significant bit in the bitmap represents the first forwarding resources in the activated RRC list, and the second bit represents the second forwarding resources, the lowest bit represents the last forwarding resources. In this way, it may mean the first and second forwarding resources in the activated RRC list requires an update to the resource information, and two fields can be also indicated in the MAC CE signaling to update the resource information for the first and second forwarding resources, respectively. In some embodiments, a new field can be added in the MAC CE signaling to indicate whether there are updated resource information in this MAC CE signaling.

Case 4: The resource information can be implicitly indicated.

1. The panel information can be implicitly indicated with at least one of following options.
Option 1: Implicitly indicated by the beam index for the access link. In some embodiments, the beams on the different panel can have different beam indexes, thus the panel information can be implicitly indicated via the beam index.
Option 2: If only one panel is operated, there may be no need to indicate panel information.
Option 3: A default panel information can be pre-defined for the NCR. If no explicit indication for the panel information, a default panel information can be considered for the beam.

2. The link-level on/off information can be implicitly indicated with at least one of following options.
Option 1: Implicitly indicated by the beam index. One or more specific beam index(es) can be used to indicate the link-level on/off state, and each specific beam index can be used to indicate the link-level on/off state for at least one of following links: forwarding link 1; forwarding link 2; forwarding link 3; or forwarding link 4. The specific beam index mentioned above can have following alternatives.
   Alt 1.1: These specific beam index can be used to indicate the link-level on/off state, and the specific beam index can also correspond to the physical beam of access link. In order to know whether the indicated specific beam index has the meaning to implicitly indicate the link-level on/off state, a higher layer parameter can be configured to enable/disable the link-level on/off indication implicitly by the beam index. In some examples, the higher layer parameter can be a bit field, where the bit value 0 may represent the specific beam index can be used to implicitly indicate the link-level on/off state, the bit value 1 may represent the disable of the link-level on/off state implicitly indicated by the specific beam index. In some examples, if this higher layer parameter is configured, it may mean that the specific beam index can also be used to implicitly indicate the link- level on/off state; if this higher layer parameter is not configured, it may mean the beam index is only used to indicate the beam information. The higher layer parameter can be configured in at least one of a RRC signaling, a MAC CE signaling, or a DCI signaling. Following examples are given to have better understanding for the Alt 1.1.
      Example 1: The specific beam index 0 may represent the access link 3 is ‘on’ while the backhaul link are ‘off’. In such way, if the NCR receives the beam indication 0 from the BS, the NCR can turn on the access link and use the access link beam 3 to finish the forwarding operation.
      Example 2: The specific beam index 0 may represent the access link 3 is ‘on’ while the backhaul link are ‘off’. A higher layer parameter can be configured for the NCR to indicate that the link-level on/off state is implicitly indicated by beam index. In such way, if the NCR receives the beam indication 0 from the BS, the NCR can turn off the backhaul link and may use the beam 1 to finish the forwarding operation. In some examples, if the higher layer parameter is not configured or configured as not enabling the link-level on/off state, when the NCR receives the beam indication 0 from BS, the NCR can directly use the beam 1 to finish the forwarding operation and may not turn off the backhaul link.
   Alt 1.2: These specific beam index can be used to indicate the link-level on/off state, and the specific beam index cannot correspond to the physical beam of the access link. In such way, if the NCR receives these specific beam index, the NCR may know/be aware of that the indicated specific beam index is not the real beam information, and it may be used to implicitly indicate the link-level on/off state.
      Example 1: If NCR has 10 beams on the access link, and the BS can use 4 bits to indicate the beam information on the access link. In such way, the beam index 11 can be used to indicate that the NCR-Fwd can turn off the access link and may keep the backhaul link on.
Option 2: In some embodiments, if the time domain resource associated with the beam for backhaul link is separate indicated from the access link, the link-level on/off state for the backhaul link and access link can be separately implicitly indicated by the beam information for access link and backhaul link. For the backhaul link, the specific beam information (e.g., the TCI state or beam index) can be used to implicitly indicate the link-level on/off state including at least one of forwarding link 1 and forwarding link 2. For the access link, the specific beam index can be used to implicitly indicate the link-level on/off state including at least one of forwarding link 3 and forwarding link 4.
Option 3: Implicitly indicated by a time division duplex (TDD) configuration. For example, if the TDD configuration for the corresponding indicated time resource is UL, it may mean that only the forwarding link 2 and 4 can be turned on, and the forwarding link 1 and 3 can be turned off. In some embodiments, a dedicated TDD configuration can be configured for the NCR-Fwd. In such way, if NCR-Fwd is used for the UL forwarding, the dedicated TDD configuration for the NCR-Fwd can have UL symbols and flexible symbols, which implicitly means that only the forwarding link 2 and 4 can be turned on, while the forwarding link 1 and 3 can be turned off.

### Implementation Example 5: Beam Information Indication for Backhaul Link

In present disclosure, since the C-link and the backhaul link operate in a same band, the beam information indication for backhaul link may share the same spatial filter of C-link, so the beam information for the backhaul link can share the same RRC configuration of beams for the C- link. However, in some cases, the spatial filter of C-link cannot be shared with the backhaul link, which means that the RRC configuration of beams for the C-link cannot be shared with the backhaul link. For example, when the C-link and the backhaul link operate in the different bands (e.g., the C-link operates in FR1 while the backhaul link operates in FR2), or when the C-link and the backhaul link operate in different panels, or when the NCR-MT and NCR-Fwd are in different locations, the RRC-configured list of TCI states for C-link cannot be shared with the backhaul link. In such way, new beam indication methods for the backhaul link can be considered.

The format of beam information for the backhaul link can refer to the options for backhaul link beam information described in the implementation example 3.

Case 1: The beam information for the backhaul link and the beam information for the access link can be indicated in the different signaling. In such way, the backhaul link beam information can be indicated via at least one of: a RRC signaling, a MAC CE signaling, or a DCI signaling, which can be a separate signaling with the beam indication for the access link. Combination of different layer signaling can be also possible to save signaling cost.
Option 1: RRC only, MAC CE only, and/or DCI only. Semi-static or common backhaul link beam information can be configured or indicated via a RRC signaling and/or a MAC CE signaling, which may not change frequently. The major benefit is to save dynamic signaling cost. For example, if a common backhaul link beam is applied for all beams indication for access link, it can be configured via a RRC signaling and/or a MAC CE signaling.
Option 2: RRC+MAC CE+DCI, RRC+DCI, MAC CE+DCI, and/or RRC+MAC CE. A set of candidate backhaul link beam information can be configured via a RRC signaling. Then MAC CE and/or DCI can be used to activate/deactivate a subset or one of the backhaul link beam from the candidate resource set. In some examples, if more than one backhaul link beam information is activated, the number of activate backhaul link beam can be same as the number of indicated access link beam. For example, a list of TCI states dedicated for the beam indication of backhaul link can be configured via a RRC signaling, the format of TCI states for the backhaul link can refer to the implementation example 3. One or more of TCI states can activated/deactivated from the list via a MAC CE signaling. For another example, a list of TCI states for the beam indication of backhaul link can be configured via a RRC signaling. One or more of TCI state can selected from the list via a DCI signaling.
Option 3: In the backhaul link beam indication of the NCR, the MAC CE signaling can be used to activate/deactivate a TCI state from the RRC configured beam list of C-link. In such case, if a list of TCI states dedicated for the beam indication of backhaul link can be configured via a RRC signaling, and the format of TCI states for the backhaul link can refer to the implementation example 3, the MAC CE signaling can be reused with some interpretations. The TCI state activated or deactivated in this MAC CE signaling can be from the dedicated TCI state list configured for the NCR-Fwd. In some embodiments, in order to differentiate whether the TCI state activated/deactivated in the MAC CE signaling is from the RRC configured beams of C-link or backhaul link, a higher layer parameter can be defined. For example, a bit field, where the bit value 1 may represent the TCI state activated/deactivated in the MAC CE signaling is from the RRC configured beams of backhaul link, and bit value 0 may represent TCI state activated/deactivated in the MAC CE signaling is from the RRC configured beams of C-link, and vice-versa, can be defined. In other examples, if this higher layer parameter is configured, it may mean that the TCI state activated/deactivated in the MAC CE signaling is from the RRC configured beams of backhaul link. If not configured, it may mean the TCI state activated/deactivated in the MAC CE signaling is from the RRC configured beams of C-link.

Case 2: The beam information for the backhaul link and the beam information for the access link can be indicated in the same signaling. In such case, at least one of following options can be considered.
Option 1: For the periodic and semi-persistent access link beam indication, the RRC signaling can be used to configure a list of forwarding resources, and each forwarding resource can be defined as {Beam index for access link, time resource}. In such way, since the backhaul link beam is always associated with the access link beam to finish the DL/UL forwarding operation, a new field can be added in the forwarding resource of the RRC signaling, which may mean that each forwarding resource is defined as {beam index for access link, beam information for the backhaul link, time resource}.
Option 2: For the periodic and semi-persistent access link beam indication, the RRC signaling can be used to configure a list of forwarding resources, and each forwarding resource can be defined as {Beam index for access link, time resource}. In such way, since the communication condition between the BS and the NCR does not change frequently, a common backhaul link beam can be considered for the indicated access link beam of all forwarding resources in the list. In such case, for the RRC signaling of periodic beam indication and RRC signaling of semi-persistent beam indication, the new field for the backhaul link beam information can be configured as part of the RRC signaling, and the same backhaul beam can be assumed for all indicated access link beam in one list of forwarding resources. In present disclosure, for the semi-persistent access link beam indication, the RRC signaling can be used to configure one or multiple list of forwarding resource. Each list may include one or multiple forwarding resources. A MAC CE signaling can be used to activate/de-activate one of all configured list in a RRC signaling. All the forwarding resources in this list can be selected. This MAC-CE signaling can also optionally provide update for beam index in the forwarding resource. In some embodiments, if the new field is added in the RRC signaling and is common for all forwarding resources in the list, the MAC CE can also optionally provide update for the beam information of backhaul link in the forwarding resource to enable the flexibility.
Option 3: In present disclosure, for the semi-persistent access link beam indication, a RRC signaling can be used to configure one or more lists of forwarding resource. Each list may include one or more forwarding resources. A MAC CE signaling can be used to activate/de- activate one of all configured list in RRC. All the forwarding resources in this list can be selected. This MAC-CE signaling can also optionally provide update for beam index in the forwarding resource. In such case, a new field can be added in the MAC CE signaling to indicate the beam information for the backhaul link, and this indicated backhaul link beam information can be common for all forwarding resources in the activated list.
Option 4: In present disclosure, for the semi-persistent access link beam indication, a RRC signaling can be used to configure one or multiple list of forwarding resource. Each list may include one or multiple forwarding resources. A MAC CE signaling can be used to activate/de-activate one of all configured list in the RRC signaling. All the forwarding resources in the list can be selected. This MAC-CE signaling can also optionally provide update for beam index in the forwarding resource. In such case, one or more fields can be added in the MAC CE signaling to indicate the beam information for the backhaul link, and the indicated backhaul link beam information can be one-to-one mapping to the forwarding resources in the activated list sequentially. The number of fields added in the MAC CE can be same as the number of forwarding resources in the activated list.
Option 5: In present disclosure, for the aperiodic access link beam indication, a list of time resource can be pre-defined by a RRC signaling. A new DCI signaling can be used with one or more fields to indicate the beam information and each field refers to one beam index, and also one or multiple fields to indicate the time resource defined by the RRC signaling. And the one or more beam information fields and one or more time resource fields are sequentially associated with one-to-one mapping. In such way, one or more fields can be added in the DCI signaling to indicate the beam information for the backhaul link, and this indicated backhaul link beam information can be associated with the access link beam information in the DCI signaling sequentially.
Option 6: In present disclosure, for the aperiodic access link beam indication, a list of time resource can be pre-defined by a RRC signaling. A new DCI signaling can be used with one or multiple fields to indicate the beam information and each field may refer to one beam index, and also one or multiple fields to indicate the time resource defined by a RRC signaling. And the one or more beam information fields and one or more time resource fields are sequentially associated with one-to-one mapping. In such way, a new field can be added in the DCI signaling to indicate the beam information for the backhaul link, and this indicated backhaul link beam information can be common for all indicated access link beam in the DCI signaling.
Option 7: In present disclosure, for the aperiodic access link beam indication, a list of time resource can be pre-defined by a RRC signaling. A new DCI signaling can be used with one or multiple fields to indicate the beam information. Each field may refer to one beam index, and also one or multiple fields to indicate the time resource defined by the RRC signaling. And the one or more beam information fields and one or more time resource fields are sequentially associated with one-to-one mapping. In such way, a new field can be added in the corresponding RRC signaling to indicate the backhaul link beam information, and this indicated backhaul link beam information can be applicable for all indicated access link beam and time resource information in the DCI signaling.

Case 3: The beam information of backhaul link can be configured in a separate signaling with the access link beam indication, and the backhaul link beam can be updated within the access link beam indication signaling. As described in the case 1 of implementation example 5, the beam information for the backhaul link can be indicated to the NCR via the signaling that is different from the access link beam indication, and all options that listed in the case 1 can be considered. In such case, in order to enable the flexibility and dynamic, following alternatives can be considered.
Alt 1: For periodic access link beam indication and/or semi-persistent access link beam indication, a new field can be added in the forwarding resource of a RRC signaling, which may mean that each forwarding resource is defined as {beam index for access link, beam information for the backhaul link, time resource}. This field can be optional. If the NCR wants to update the backhaul link beam for some forwarding resources, this field can be configured in the forwarding resource. If not configured, the backhaul beam associated with the indicated access link beam can refer to the beam information of backhaul link indicated in a separate signaling as described in the case 1 of implementation example 5.
Alt 2: For semi-persistent access link beam indication, the MAC CE signaling can optionally update the backhaul link beam information for some forwarding resources in the activated list.

Case 4: In order to finish the UL forwarding operation, the UL reception beam used for the access link and the UL transmitting beam used for the backhaul link can be known for the NCR. For the DL forwarding operation, the DL reception beam for the backhaul link and DL transmitting beam for the access link can be known for the NCR. In such way, the beam used for the access link and the beam used for the backhaul link can be configured together as a beam pair to the NCR for the forwarding operation.

Considering that there are multiple beams for the access link and backhaul link, one or more beam pair list, where each beam pair list includes one or more beam pairs with each beam pair including a beam index for access link and a beam information (e.g., beam index or TCI state) for backhaul link, can be configured for the NCR. In some embodiments, each beam pair list can have a list index. In some examples, each beam pair in the beam pair list may have a beam pair index. The beam pair list can be indicated to the NCR from the BS via at least one of: a RRC signaling, a MAC CE signaling, or a DCI signaling, or configured to the NCR and the BS via an OAM.

In other examples, since the self-interference may occur for the NCR-Fwd, the configured beam pair list can be configured to the NCR to represent that these beam pairs are used for a self-interference measurement. In other examples, this beam pair list can be configured for the NCR to represent that these beam pairs may not cause the self-interference issues.

Following aspects can be considered for the beam information indication of backhaul link and access link when one or more beam pair list is configured to the NCR.

Aspect-1: the format of configured beam pair list. As for each beam pair list, it can include one or more beam pairs. For each beam pair, it may include a beam index that is used to represent an access link beam and beam information that can be used to indicate the beam of backhaul link.
Option 1: The access link beam in the different beam pairs can be same or different, and the backhaul beam information in the different beam pairs can also be same or different, which means that there is no limit for the configured beam pair list. Following examples are given to have a clear illustration for the format of beam pair list.
   Example 1: Assuming that there are 8 beams indexing with 0-7 for the access link, and 4 beams indexing with 0-3 for the backhaul link. A beam pair list can be configured for the NCR (e.g., Table 1). As shown in Table 1, for the beam pair index 0 and 1, they both includes access link beam 1, but includes different backhaul link beam (e.g., backhaul link beam 1 and backhaul link beam 2). While as for the beam pair index 0 and 2, they both includes backhaul beam 1, but includes different access link beam (e.g., access link beam 1 and access link beam 3).

TABLE 1

| | Access link beam information | Backhaul link beam |
|---|---|---|
| Beam pair index | field | information field |
| 0 | Access link beam 1 | backhaul link beam 1 |
| 1 | Access link beam 1 | backhaul link beam 2 |
| 2 | Access link beam 3 | backhaul link beam 1 |
| 3 | Access link beam 4 | backhaul link beam 3 |
| 4 | Access link beam 5 | backhaul link beam 0 |

Example 2: Assuming that there are 8 beams indexing with 0-7 for the access link, and 4 beams indexing with 0-3 for the backhaul link. A beam pair list can be configured for the NCR (e.g., Table 2). As shown in Table 2, different beam pairs have different access link beam and different backhaul link beam.

TABLE 2

| | Access link beam information | Backhaul link beam |
|---|---|---|
| Beam pair index | field | information field |
| 0 | Access link beam 0 | backhaul link beam 0 |
| 1 | Access link beam 1 | backhaul link beam 2 |
| 2 | Access link beam 3 | backhaul link beam 1 |
| 3 | Access link beam 4 | backhaul link beam 3 |

Option 2: For each beam pair, it may include different access link beam, while the backhaul link beam in each beam pair can be same or different, which means that each access link beam of NCR can be linked to one backhaul beam in the configured beam pair list.
   Example 1: Assuming that there are 5 beams indexing with 0-4 for the access link, and 4 beams indexing with 0-3 for the backhaul link. A beam pair list can be configured for the NCR (e.g., Table 3). As shown in Table 3, different access link beam may include in the different beam pair of the list, while the backhaul link beam in each beam pair can be same or different.

TABLE 3

| | Access link beam information | Backhaul link beam |
|---|---|---|
| Beam pair index | field | information field |
| 0 | Access link beam 0 | backhaul link beam 0 |
| 1 | Access link beam 1 | backhaul link beam 1 |
| 2 | Access link beam 2 | backhaul link beam 1 |
| 3 | Access link beam 3 | backhaul link beam 2 |
| 4 | Access link beam 4 | backhaul link beam 3 |

Aspect-2: the method of backhaul link beam indication. When the beam pair list is configured for the NCR as described in the aspect 1 of implementation example 5, following options can be considered for the beam indication of access link and backhaul link of NCR.
Option 1: Since the beam pair has included the beam information of backhaul link and beam information of access link, the beam pair index can be used for the beam information indication. In such way, the access link beam information field can be re-interpreted as the beam pair index. Specifically, for period and semi-persistent beam indication for access link, the beam information field in the forwarding resource of current RRC signaling can be re-interpreted as a beam pair index. For the aperiodic beam indication of access link, the beam information field in the corresponding DCI signaling can be re-interpreted as the beam pair index. In some examples, in order to let the NCR know whether the corresponding beam information field is represent the access link beam index or the beam pair index, a higher layer parameter can be configured to the NCR from the BS to determine the meaning of the beam information field in the access link beam signaling. For example, a bit field, where the bit value 1 may represent the current beam information field in the access link beam signaling is for the access link beam index, and bit value 0 may represent the current beam information field in the access link beam signaling is for the beam pair index, and vice-versa, can be defined. In other examples, if this higher layer parameter is configured, it may mean that the current beam information field in the access link beam signaling is for the beam pair index. If not configured, it may mean that the current beam information field in the access link beam signaling is still for the access link beam index. In present disclosure, for the semi-persistent access link beam indication, a RRC signaling can be used to configure one or more list of forwarding resource. Each list may include one or multiple forwarding resources. A MAC CE signaling can be used to activate/de-activate one of all configured list in a RRC signaling. All the forwarding resources in this list can be selected. This MAC-CE signaling can also optionally provide update for access link beam index in the forwarding resource. In some embodiments, if the current beam information field in the forwarding resource of RRC signaling is used for the beam pair index, the MAC CE can also optionally provide update for the beam information of backhaul link for some forwarding resource in the activated RRC list to enable the flexibility.
Option 2: The beam information field for the access link in the periodic access link beam indication, the semi-persistent access link beam indication, and the aperiodic access link beam indication signaling can be reused. Once the NCR receives the access link beam indication, the NCR can check the beam pair list based on the indicated access link beam index and obtain the corresponding backhaul link beam information. Following two alternatives can be considered.
   Alt 2.1: The beam pair list can be configured to the NCR and for each beam pair, which includes the different access link beam, while the backhaul link beam in each beam pair can be same or different, which may mean that each access link beam of NCR can only be linked to one backhaul beam in the configured beam pair list. Following is an example of configured beam pair list.
      Example 1: Assuming that access links include 5 beams indexing with 0-4, and backhaul links include 4 beams indexing with 0-3. In this case, when the NCR receives the access link beam indication, it can inquire the beam pair list and obtain one corresponding backhaul link beam that can be used associated with each indicated access link beam index. For example, according to Table 4, when the NCR receives two access link beam index 0 and 1, it can obtain that the backhaul beam 0 can be used associated with the access link beam 0 and the backhaul beam 2 can be used associated with the access link beam 1. For the semi-persistent access link beam indication, RRC signaling can be used to configure one or more list of forwarding resource. Each list can include one or more forwarding resources. A MAC CE signaling can be used to activate/de-activate one of all configured list in a RRC signaling. All the forwarding resources in this list can be selected. This MAC-CE signaling can also optionally provide update for access beam index in the forwarding resource. In some embodiments, if the current beam information field in the forwarding resource of RRC signaling is still used for the access link beam, the backhaul link can be obtained from the beam pair list according to the indicated access link beam. The MAC CE signaling can also optionally provide update for the beam information of backhaul link for some forwarding resource to enable the flexibility.

TABLE 4

| | Access link beam information | Backhaul link beam |
|---|---|---|
| Beam pair index | field | information field |
| 0 | Access link beam 0 | backhaul link beam 0 |
| 1 | Access link beam 1 | backhaul link beam 2 |
| 2 | Access link beam 2 | backhaul link beam 1 |
| 3 | Access link beam 3 | backhaul link beam 3 |
| 4 | Access link beam 4 | backhaul link beam 1 |

Alt 2.2: The beam pair list is configured to the NCR, and the access link beam in the different beam pairs can be same or different. The backhaul beam information in the different beam pairs can also be same or different. Following are an example of configured beam pair list:
   Example 1: assuming access link has 5 beams indexing with 0-4, bachaul links has 4 beams indexing with 0-3:

TABLE 5

| | Access link beam information | Backhaul link beam |
|---|---|---|
| Beam pair index | field | information field |
| 0 | Access link beam 0 | backhaul link beam 0 |
| 1 | Access link beam 1 | backhaul link beam 2 |
| 2 | Access link beam 2 | backhaul link beam 1 |
| 3 | Access link beam 3 | backhaul link beam 3 |
| 4 | Access link beam 4 | backhaul link beam 1 |
| 5 | Access link beam 4 | backhaul link beam 2 |
| 6 | Access link beam 0 | backhaul link beam 1 |

In this case, when the NCR receives the access link beam indication, it can inquire the beam pair list and obtain one or more backhaul link beam that will be used associated with the each indicated access link beam index. If only one backhaul beam is associated with the access link beam index, the NCR can use the access link beam and corresponding backhaul link beam to finish the forwarding operation. If more than one backhaul link beams are associated with the indicated access link beam index, the NCR can determine its action according to whether it supports the simultaneous transmission on these backhaul link beams. If supported simultaneous transmission, the NCR can use all these backhaul link beams to simultaneously finish the forwarding operation in the indicated time and/or frequency domain resource associated with the indicated access link beam. If not supported, the NCR can determine the backhaul link beam that associated with the access link beam based on a pre-defined rule (e.g., select the backhaul link beam that corresponds to the first defined access link beam index in the beam pair list). For example according to Table 5, when the NCR receives the access beam index 4, then it can inquire the beam pair list and obtain two backhaul link beams with index 1 and 2. In this case, if NCR supports the simultaneous transmission on the backhaul link beam 1 and 2, it can simultaneously use these two backhaul beams together with the access link beam 4 to finish the forwarding operation. If the NCR does not support the simultaneous transmission on the backhaul link beam 1 and 2, it can choose the bachaul link beam 1 based on the pre-defined rule, e.g., the first defined access link beam 4 is beam pair 4, and the backhaul link beam in the beam pair 4 is the backhaul link beam 1.

For the semi-persistent access link beam indication, RRC signaling can be used to configure one or more list of forwarding resource, each list is consisted of one or more forwarding resources. And MAC CE signaling can be used to activate/de-activate one of all configured list in RRC, thus all the forwarding resources in this list can be selected. This MAC-CE signaling can also optionally provide update for access beam index in the forwarding resource. In this way, in some embodiment, if the current beam information field in the forwarding resource of RRC signaling is still used for the access link beam, then the backhaul link can be obtained from the beam pair list according to the indicated access link beam. Then the MAC CE can also optionally provide update for the beam information of backhaul link for some forwarding resource to enable the flexibility.
Option 3: As introduced in the case 1 of implementation example 5, a new dedicated signaling can be defined to indicate the beam information for the backhaul link, and all options listed in the case 1 of implementation example 5 can be considered for the new signaling. In some embodiments, if there is no dedicated signaling to indicate the backhaul link beams, or no valid indicated backhaul link beam information, or no activated backhaul link beam, the NCR can inquire the configured beam pair list according to the indicated access link beam index to obtain the corresponding backhaul link beams. The beam pair list can be configured to the NCR, and the access link beam in the different beam pairs can be same or different. The backhaul beam information in the different beam pairs can also be same or different. In such way, when the NCR receives the access link beam indication, it can inquire the beam pair list and obtain one or more backhaul link beam that can be used associated with the each indicated access link beam index. If only one backhaul beam is associated with the access link beam index, the NCR can use the access link beam and corresponding backhaul link beam to finish the forwarding operation. If more than one backhaul link beams are associated with the indicated access link beam index, the NCR can determine its action according to whether it supports the simultaneous transmission on these backhaul link beams. If supported simultaneous transmission, the NCR can use all these backhaul link beams to simultaneously finish the forwarding operation in the indicated time and/or frequency domain resource associated with the indicated access link beam. If not supported, the NCR can determine the backhaul link beam that associated with the access link beam based on a pre-defined rule (e.g., select the backhaul link beam that corresponds to the first defined access link beam index in the beam pair list).
Option 4: As introduced in the case 2 of implementation example 5, a new field can be added in the current access link beam indication signaling to indicate the beam information for the backhaul link, and all options listed in the case 2 of implementation example 5 can be considered for the new field. In some embodiment, this new added field is optional, and if there is no explicitly indicated backhaul link beam for the indicated access link beam, the NCR can inquire the configured beam pair list according to the indicated access link beam index to obtain the corresponding backhaul link beams. The beam pair list can be configured to the NCR, and the access link beam in the different beam pairs can be same or different. The backhaul beam information in the different beam pairs can also be same or different. In such way, when the NCR receives the access link beam indication, it can inquire the beam pair list and obtain one or more backhaul link beam that can be used associated with the each indicated access link beam index. If only one backhaul beam is associated with the access link beam index, the NCR can use the access link beam and corresponding backhaul link beam to finish the forwarding operation. If more than one backhaul link beams are associated with the indicated access link beam index, the NCR can determine its action according to whether it supports the simultaneous transmission on these backhaul link beams. If supported simultaneous transmission, the NCR can use all these backhaul link beams to simultaneously finish the forwarding operation in the indicated time and/or frequency domain resource associated with the indicated access link beam. If not supported, the NCR can determine the backhaul link beam that associated with the access link beam based on a pre-defined rule (e.g., select the backhaul link beam that corresponds to the first defined access link beam index in the beam pair list, or the last defined access link beam index in the beam pair list).

As mentioned in the above options of case 1, case2, case3, case 4 of implementation example 5, the MAC CE signaling can be used to update the backhaul link beam information for some forwarding resources in the activated RRC list. In the way, following options can be considered for the format of MAC CE signaling to update the backhaul link beam information.
Option 1: One or more fields can be added in the MAC CE signaling to indicate the forwarding resource index, and one or more fields can be added in the MAC CE signaling to indicate the updated backhaul link beam information. The one or more fields for forwarding resource index and one or more fields for updated backhaul link beam information is sequentially associated with one-to-N (with N≥1) mapping or N-to-one (with N≥1) mapping. For example, there are 5 forwarding resource in the activated RRC list, and the backhaul link beam information that applicable for all forwarding resources is configured to the NCR. And the BS wants to update the backhaul link beam information for the forwarding resource 1 and forwarding resource 2. In this case, there are two fields added in the MAC CE signaling to indicate the forwarding resource index 1 and forwarding resource index 2, and two fields added in the MAC CE signaling to update the backhaul link beam for these two forwarding resources respectively, which means the fields for forwarding resource index and fields for updated backhaul link beam is one-to-one mapping. For another examples, if the updated backhaul link beam is same for these two forwarding resources, two fields added in the MAC CE signaling to indicate the forwarding resource index 1 and forwarding resource index 2, and one field is added in the MAC CE signaling to update the backhaul link beam that applicable for these two forwarding resources, which means the fields for forwarding resources and fields for updated backhaul link beam is N-to-one (N>1) mapping. In some embodiments, a new field is added in the MAC CE signaling to indicate whether there exists updated backhaul link beam information in this MAC CE signaling.
Option 2: A bitmap can be indicated in the MAC CE signaling to indicate which one or more forwarding resources are needed to update the backhaul link beam information, where each bit in the bitmap is corresponding to a forwarding resource and the bit value represents whether or not the corresponding forwarding resource needs to update the backhaul link beam information. And if there are one or more forwarding resources needs to update the backhaul link beam information, one or more fields can be added in the MAC CE signaling to indicate the updated backhaul link beam information for corresponding forwarding resources, respectively. For example, the bit value 1 represents the corresponding forwarding resource needs to update the backhaul link beam information while the bit value 0 represents the corresponding forwarding resources does no need to update the backhaul link beam information, or vice versa. For example, if the activated RRC list includes 3 forwarding resources, a bitmap 110 including 3 bits can be used in the MAC CE signaling, the lowest bit in the bitmap is corresponding to the first forwarding resources in the activated RRC list, and second bit represents the second forwarding resources in the activated RRC list, the most significant bit in the bitmap represents the last forwarding resources in the activated RRC list. In this way, if bit value 1 represents the corresponding forwarding resources needs to update the backhaul link beam information, it may mean the second and last forwarding resources needs to update the backhaul link beam information, then two fields is indicated in the MAC CE signaling to indicate the updated backhaul link beam information for the second and last forwarding resources, respectively. For another example, if the most significant bit in the bitmap represents the first forwarding resources in the activated RRC list, and the second bit represents the second forwarding resources, the lowest bit represents the last forwarding resources. In this way, it may mean the first and second forwarding resources in the activated RRC list is needed to update the backhaul link beam information, and two fields is also indicated in the MAC CE signaling to update the backhaul link beam information for the first and second forwarding resources, respectively. In some embodiments, a new field can be added in the MAC CE signaling to indicate whether there exists updated backhaul link beam information in this MAC CE signaling.

It should be understood that one or more features from the above implementation examples are not exclusive to the specific implementation examples, but can be combined in any manner (e.g., in any priority and/or order, concurrently or otherwise).

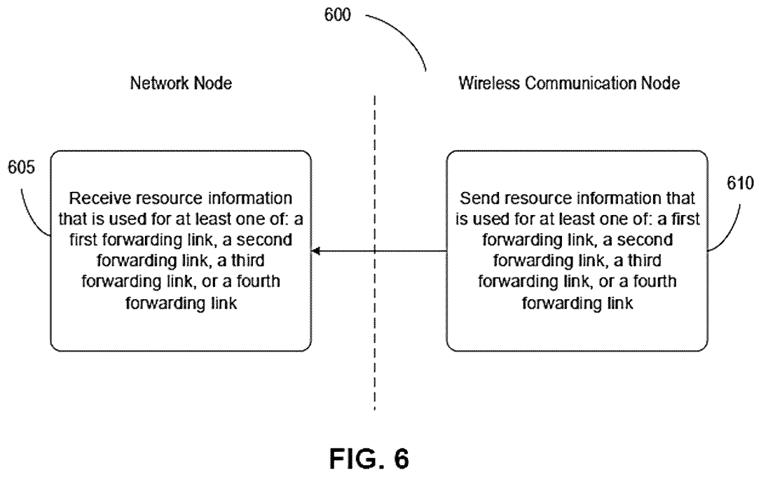

FIG. 6 illustrates a flow diagram of a method 600 for resource information indication. The method 600 may be implemented using any one or more of the components and devices detailed herein in conjunction with FIGS. 1-2. In overview, the method 600 may be performed by a network node, in some embodiments. Additional, fewer, or different operations may be performed in the method 600 depending on the embodiment. At least one aspect of the operations is directed to a system, method, apparatus, or a computer-readable medium.

A network node may receive, from a wireless communication node, resource information that is used for at least one of: a first forwarding link, a second forwarding link, a third forwarding link, or a fourth forwarding link. The first forwarding link can be from the wireless communication node to the network node. The second forwarding link can be from the network node to the wireless communication node. The third forwarding link can be from the network node to a wireless communication device. The fourth forwarding link can be from the wireless communication device to the network node. The resource information may include at least one of: beam information for access links, or additional information. The additional information may comprise at least one of: frequency information for the access links, panel information for the access links, link-level on/off information, beam information for backhaul links, frequency information for the backhaul links, panel information for the backhaul links, or uplink (UL)/downlink (DL) information. The backhaul links may include the first forwarding link and the second forwarding link. The access links may include the third forwarding link and the fourth forwarding link.

In some embodiments, prior to the network node receiving the resource information, the wireless communication node may have received capability information of the network node. The capability information can be sent to the wireless communication node from an Operations, Administration and Maintenance (OAM) entity. The capability information can be reported from the network node to the wireless communication node. The capability information may include at least one of: a frequency information allocation on access links and/or backhaul links; a simultaneous beam operation capability on the access links and/or the backhaul links; a frequency shift capability; or a sub-band non-overlapping full duplex (SBFD) capability.

In some embodiments, the frequency information includes at least one of following formats: a carrier index, a passband index, a bandwidth part (BWP) index, a subband index, a cell identifier (ID), a starting physical resource block (PRB), a starting resource element (RE), an ending PRB, an ending RE, a number of consecutive PRBs, a number of REs, a RB offset, a RE offset, an absolute radio frequency channel number (ARFCN), or a global synchronization raster channel number (GCSN). The panel information includes at least one of following formats: a panel identity or index, or an antenna group ID or index. The link-level on/off information can be used to indicate an on/off status that is applicable for at least one of: the first forwarding link, the second forwarding link, the third forwarding link, or the fourth forwarding link. The beam information for the backhaul links can be in one of the following formats: a beam index, or a transmission configuration indication (TCI) state.

In some embodiments, when the beam information for the backhaul links is in the format of TCI state, a list that includes one or more TCI states can be configured for the network node to be used for a backhaul link beam information indication. The list can be configured to the network node by the wireless communication node via at least one of: a radio resource control (RRC) signaling, a medium access control control element (MAC CE) signaling, or a downlink control information (DCI) signaling. A set of logic reference signals that is used in a TCI state can be defined for the network node. A set of logic reference signals can be one-to-one mapping to physical backhaul link beams. A new type of TCI state may include a logic beam index which is defined for the network node, and the logic beam index can be one-to-one mapping to physical backhaul link beams. At least one of additional information can be indicated in a same radio resource control (RRC) signaling that is used for a periodic beam information indication of the access links. A format of indication for each type of additional information is one of: the additional information is indicated in a pair with a beam index for the access links configured in a list by a RRC signaling, and each access link beam has the associated corresponding additional information; one field is added to indicate the additional information, and is applicable for all access link beams configured in a list by RRC signaling.

In some embodiments, at least one of additional information can be indicated in a same RRC signaling that used for the semi-persistent beam information indication of access links. A format of indication for each type of additional information can be one of: the additional information is indicated in a pair with a beam index for the access links configured in a list by a radio resource control (RRC) signaling; or one field is added to indicate the additional information, and is applicable for all beam index for the access links configured in the list by the RRC signaling. At least one of additional information can be indicated in a same medium access control control element (MAC CE) signaling used for a semi-persistent beam indication of the access links. A format of indication for each type of additional information can be one of: one or more fields are added in the MAC CE signaling to indicate one or more additional information, and the one or more additional information is one-to-one mapping to an indicated beam index information of the access links activated in the MAC CE signaling; or one field is added to indicate the additional information, and is applicable for all beam index information of the access links activated in the MAC CE signaling.

In some embodiments, at least one of additional information can be indicated in a same radio resource control (RRC) signaling and a medium access control control element (MAC CE) signaling that are used for a semi-persistent beam indication of the access links. A format of indication for each type of additional information may include: one field is added in the RRC signaling to indicate the additional information, and is applicable for all beam index for the access links configured in a list by the RRC signaling; and one or more fields are added in the MAC CE signaling to update one or more additional information that is used for specific indicated access link beam information. At least one of additional information can be indicated in a same downlink control information (DCI) signaling that is used for an aperiodic beam indication of the access links. A format of indication for each type of additional information can be one of: one or more fields are added in the DCI signaling to indicate the one or more additional information, and is one-to-one mapping to an indicated beam index information of the access links; or one field is added in the DCI signaling to indicate the additional information, and is applicable for all indicated beam index information of the access links.

In some embodiments, at least one of additional information can be indicated in a new signaling. The new signaling may comprise at least one of: a radio resource control (RRC) signaling, a medium access control control element (MAC CE) signaling, or a downlink control information (DCI) signaling. The panel information for the access links can be implicitly indicated by a specific beam index for the access links. The link-level on/off information can be implicitly indicated by a specific beam index for the access links. The link-level on/off information can be implicitly indicated by a time division duplex (TDD) configuration.

In some embodiments, when backhaul link beam information is in a format of transmission configuration indication (TCI) state, a medium access control control element (MAC CE) signaling that used to activate or deactivate one TCI state for backhaul link from a radio resource control (RRC) configured TCI state list of control link is reused to indicate one or more TCI state activated or deactivated from a RRC configured TCI state list for the backhaul link, and the control link includes the first control link from wireless communication node to a network node and the second control link from network node to wireless communication node A higher layer parameter can be defined for the network node to differentiate whether the indicated TCI state in the MAC CE signaling is from the RRC configured TCI state list of the backhaul link or from the RRC configured beams of control link. Backhaul link beam information can be indicated in a new signaling comprises at least one of: a radio resource control (RRC) signaling, a medium access control control element (MAC CE) signaling, or a downlink control information (DCI) signaling. When the wireless communication node updates the backhaul link beam information for one or more indicated access link beams, the RRC signaling used for a periodic and/or a semi-persistent access link beam indication can be used to update the backhaul link beam information for one or more indicated access link beam indexes. A field for backhaul link beam indication can be indicated in a pair with a field for a beam index for the access links configured in a list by the RRC signaling. When the field of the backhaul link beam indication is not indicated in the RRC signaling for periodic access link beam indication, the backhaul link beam information associated with a corresponding access link beam can be refer to the backhaul link beam information indicated in the new signaling. When the wireless communication node updates the backhaul link beam information for one or more indicated access link beams of a semi-persistent access link beam indication, the MAC CE signaling that used for the semi-persistent access link beam indication can be used to update the backhaul link beam information for one or more indicated access link beam indexes. One or more fields for backhaul link beam indication can be added in the MAC CE signaling to update the corresponding backhaul link beam information for one or more indicated access link beams activated in the MAC CE signaling. When the backhaul link beam indication for an access link beam is not updated in the MAC CE signaling for semi-persistent access link beam indication, the backhaul link beam information associated with a corresponding access link beam can be refer to the backhaul link beam information indicated in the new signaling.

In some embodiments, the network node may receive, from the wireless communication node, a list including one or more beam pairs, each of the beam pair including a first beam index configured for the access links and a second beam information configured for the backhaul links. Each beam pairs in the list may have a corresponding beam pair index. The list can be configured to the network node from the wireless communication node via at least one of: a radio resource control (RRC) signaling, a medium access control control element (MAC CE) signaling, or a downlink control information (DCI) signaling. The list can be configured to the network node via an Operations, Administration and Maintenance (OAM) entity. Access link beam information in different beam pairs of the list can be same or different. Backhaul link beam information in different beam pairs of the list can be same or different. In certain embodiments, access link beam information in different beam pairs of the list can be different, and backhaul link beam information in different beam pairs of the list can be same or different.

In some embodiments, an access link beam information field can be reinterpreted to be used to indicate a beam pair index. A higher layer parameter can be configured to the network node to indicate whether the access link beam information field is used to indicate the beam pair index or access link beam index. The backhaul link beam information can be directly obtained from the beam pair list according to an indicated access link beam index. When more than one backhaul link beam is obtained for an associated indicated access link beam and the network node supports a simultaneous beam transmission on backhaul link beams, the network node may simultaneously use the backhaul link beams together with the associated access link beam. When more than one backhaul link beam is obtained for an associated indicated access link beam and the network node does not support a simultaneous beam transmission on backhaul link beams, a pre-defined rule can be defined for the network node to determine the backhaul link beam information for the associated access link beam. The pre-defined rule may include at least one of: the backhaul link beam corresponding to the associated access link beam that is first defined in the beam pair list; or the backhaul link beam corresponding to the associated access link beam that is last defined in the beam pair list, or a default backhaul link beam. One or more field can be added in a medium access control control element (MAC CE) signaling of a semi-persistent access link beam information to update the backhaul link beam information for indicated access link beam information activated in the MAC CE signaling.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a network node from a wireless communication node, resource information that is used for at least one of: a first forwarding link, a second forwarding link, a third forwarding link, or a fourth forwarding link,
wherein the first forwarding link is from the wireless communication node to the network node, the second forwarding link is from the network node to the wireless communication node, the third forwarding link is from the network node to a wireless communication device, and the fourth forwarding link is from the wireless communication device to the network node.

2. The wireless communication method of claim 1, wherein the resource information includes at least one of:
beam information for access links, or
additional information comprising at least one of:
frequency information for the access links,
panel information for the access links,
link-level on/off information,
beam information for backhaul links,
frequency information for the backhaul links,
panel information for the backhaul links, or
uplink (UL)/downlink (DL) information;
wherein the backhaul links include the first forwarding link and the second forwarding link, the access links include the third forwarding link and the fourth forwarding link.

3. The wireless communication method of claim 1, wherein, prior to the network node receiving the resource information, the wireless communication node has received capability information of the network node.

4. The wireless communication method of claim 3, wherein the capability information is sent to the wireless communication node from an Operations, Administration and Maintenance (OAM) entity.

5. The wireless communication method of claim 3, wherein the capability information is reported from the network node to the wireless communication node.

6. The wireless communication method of claim 3, wherein the capability information includes at least one of:
a frequency information allocation on access links and/or backhaul links;
a simultaneous beam operation capability on the access links and/or the backhaul links;
a frequency shift capability; or
a sub-band non-overlapping full duplex (SBFD) capability.

7. The wireless communication method of claim 2, wherein the frequency information includes at least one of following formats: a carrier index, a passband index, a bandwidth part (BWP) index, a subband index, a cell identifier (ID), a starting physical resource block (PRB), a starting resource element (RE), an ending PRB, an ending RE, a number of consecutive PRBs, a number of REs, a RB offset, a RE offset, an absolute radio frequency channel number (ARFCN), or a global synchronization raster channel number (GCSN).

8. The wireless communication method of claim 2, wherein the panel information includes at least one of following formats: a panel identity or index, or an antenna group ID or index.

9. The wireless communication method of claim 2, wherein the link-level on/off information is used to indicate an on/off status that is applicable for at least one of: the first forwarding link, the second forwarding link, the third forwarding link, or the fourth forwarding link.

10. The wireless communication method of claim 2, wherein the beam information for the backhaul links is in one of following formats: a beam index, or a transmission configuration indication (TCI) state.

11. The wireless communication method of claim 10, wherein when the beam information for the backhaul links is in the format of TCI state, a list that includes one or more TCI states is configured for the network node to be used for a backhaul link beam information indication.

12. The wireless communication method of claim 11, wherein the list is configured to the network node by the wireless communication node via at least one of: a radio resource control (RRC) signaling, a medium access control control element (MAC CE) signaling, or a downlink control information (DCI) signaling.

13. The wireless communication method of claim 11, wherein a set of logic reference signals that is used in a TCI state is defined for the network node, and a set of logic reference signals is one-to- one mapping to physical backhaul link beams.

14. The wireless communication method of claim 11, wherein a new type of TCI state includes a logic beam index which is defined for the network node, and the logic beam index is one-to-one mapping to physical backhaul link beams.

15. The wireless communication method of claim 2, wherein at least one of additional information is indicated in a same radio resource control (RRC) signaling that is used for a periodic beam information indication of the access links.

16. The wireless communication method of claim 15, wherein a format of indication for each type of additional information is one of:
the additional information is indicated in a pair with a beam index for the access links configured in a list by a RRC signaling, and each access link beam has the associated corresponding additional information; or
one field is added to indicate the additional information, and is applicable for all access link beams configured in a list by RRC signaling.

17. The wireless communication method of claim 2, wherein at least one of additional information is indicated in a same RRC signaling that used for the semi-persistent beam information indication of access links.

18. A network node, comprising:
at least one processor configured to:
receive, via a receiver from a wireless communication node, resource information that is used for at least one of: a first forwarding link, a second forwarding link, a third forwarding link, or a fourth forwarding link,
wherein the first forwarding link is from the wireless communication node to the network node, the second forwarding link is from the network node to the wireless communication node, the third forwarding link is from the network node to a wireless communication device, and the fourth forwarding link is from the wireless communication device to the network node.

19. A wireless communication method, comprising:
sending, by a wireless communication node to a network node, resource information that is used for at least one of: a first forwarding link, a second forwarding link, a third forwarding link, or a fourth forwarding link,
wherein the first forwarding link is from the wireless communication node to the network node, the second forwarding link is from the network node to the wireless communication node, the third forwarding link is from the network node to a wireless communication device, and the fourth forwarding link is from the wireless communication device to the network node.

20. A wireless communication node, comprising:
at least one processor configured to:
send, via a transmitter to a network node, resource information that is used for at least one of:
a first forwarding link, a second forwarding link, a third forwarding link, or a fourth forwarding link,
wherein the first forwarding link is from the wireless communication node to the network node, the second forwarding link is from the network node to the wireless communication node, the third forwarding link is from the network node to a wireless communication device, and the fourth forwarding link is from the wireless communication device to the network node.
